(19) United States
(12) Patent Application Publication
(10) Pub. No.: US 2019/0289650 A1
(43) Pub. Date: Sep. 19, 2019

(54) METHOD AND APPARATUS FOR ESTABLISHING RADIO BEARER

(71) Applicant: SAMSUNG ELECTRONICS CO., LTD., Suwon-si (KR)

(72) Inventors: Seungbo YOO, Suwon-si (KR); Dongmin KIM, Suwon-si (KR); Namryul JEON, Suwon-si (KR); Sungchul HONG, Suwon-si (KR); Youngsung KHO, Suwon-si (KR); Daejoong KIM, Suwon-si (KR); Kyuho HAN, Suwon-si (KR)

(73) Assignee: SAMSUNG ELECTRONICS CO., LTD., Suwon-si (KR)

(21) Appl. No.: 16/353,541

(22) Filed: Mar. 14, 2019

(30) Foreign Application Priority Data
Mar. 14, 2018 (KR) 10-2018-0029540

(51) Int. Cl. H04W 76/12

(52) U.S. Cl. CPC H04W 76/12; H04W 84/042

(57) ABSTRACT

A method of establishing a radio bearer by a User Equipment (UE) in a wireless communication system supporting a plurality of communication systems is provided. The method includes: receiving first core information related to a plurality of core networks from an evolved NodeB (eNB); selecting one of the plurality of core networks based on the first core information; transmitting second core information related to the selected core network to the eNB; and establishing a Signaling Radio Bearer (SRB) corresponding to the selected core network.

### CROSS-REFERENCE TO RELATED APPLICATION

This application is based on and claims priority under 35 U.S.C. 119 to Korean Patent Application No. 10-2018-0029540, filed on Mar. 14, 2018, in the Korean Intellectual Property Office, the disclosures of which are incorporated by reference herein in its entirety.

### BACKGROUND

### 1. Field

The disclosure relates to a method and an apparatus for configuring a radio bearer in a wireless communication system supporting a plurality of communication systems.

### 2. Description of Related Art

In order to meet wireless data traffic demands that have increased after 4th Generation (4G) communication system commercialization, efforts to develop an improved 5G communication system or a pre-5G communication system have been made. For this reason, the 5G communication system or the pre-5G communication system is called a beyond 4G network communication system or a post-LTE system.

In order to achieve a high data transmission rate, implementation of the 5G communication system in a mmWave band (e.g., 60 GHz band) is being considered. In the 5G communication system, technologies such as beamforming, massive Multiple-Input Multiple-Output (MIMO), Full Dimensional MIMO (FD-MIMO), an array antenna, analog beam-forming, and a large scale antenna are being discussed to mitigate a propagation path loss in the mmWave band and increase propagation transmission distance.

Further, technologies such as an evolved small cell, an advanced small cell, a cloud Radio Access Network (cloud RAN), an ultra-dense network, Device to Device communication (D2D), a wireless backhaul, a moving network, cooperative communication, Coordinated Multi-Points (CoMP), and interference cancellation have been developed to improve the system network in the 5G communication system.

In addition, Advanced Coding Modulation (ACM) schemes such as Hybrid FSK and QAM Modulation (FQAM) and Sliding Window Superposition Coding (SWSC), and advanced access technologies such as Filter Bank Multi Carrier (FBMC), Non Orthogonal Multiple Access (NOMA), and Sparse Code Multiple Access (SCMA) have been developed for the 5G system.

### SUMMARY

Provided are a method and an apparatus for establishing a Signaling Radio Bearer (SRB) in a wireless communication system supporting a plurality of communication systems.

Further, provided are a method and an apparatus for establishing a signaling radio bearer through triggering by a user equipment (UE) in a wireless communication system supporting a plurality of communication systems.

Further still, provided are a method and an apparatus for establishing a signaling radio bearer through triggering by a core network in a wireless communication system supporting a plurality of communication systems.

Further still, provided are a method and an apparatus for establishing a signaling radio bearer during a handover procedure in a wireless communication system supporting a plurality of communication systems.

Further still, provided are provide a method and an apparatus for selecting one of a plurality of core networks according to a core network linked to a UE and establishing a signaling radio bearer during an initial access procedure in a wireless communication system supporting a plurality of communication systems.

In accordance with an aspect of the disclosure, there is provided a method for a User Equipment (UE) in a wireless communication system supporting a plurality of communication systems, the method including: receiving first core information related to a plurality of core networks from a base station (BS); selecting a core network of the plurality of core networks based on the first core information; transmitting, to the BS, second core information related to the selected core network; and establishing a Signaling Radio Bearer (SRB) between the UE and the selected core network, based on the second core information.

The receiving the first core information may include receiving the first core information through at least one of a System Information Block (SIB), a Master Information Block (MIB), a Random Access Response (RAR), and a paging message.

The transmitting second core information may include transmitting the second core information through a Radio Resource Control (RRC) message.

The method may further include transmitting a Non-Access-Stratum (NAS) message that corresponds to the selected core network, and includes an attach request message.

The transmitting the NAS message may include transmitting the NAS message through an RRC connection setup complete message.

In accordance with an aspect of the disclosure, there is provided a method for a base station (BS) in a wireless communication system supporting a plurality of communication systems, the method including: transmitting first core information related to a plurality of core networks to a User Equipment (UE); receiving, from the UE, second core information related to a core network selected from the plurality of core networks; and establishing a Signaling Radio Bearer (SRB) between the UE and the selected core network, based on the second core information.

The transmitting the first core information may include transmitting the first core information through at least one of a System Information Block (SIB), a Master Information Block (MIB), a Random Access Response (RAR), and a paging message.

Receiving the second core information may include receiving the second core information through a Radio Resource Control (RRC) message.

The method may further include: receiving, from the UE, a Non-Access-Stratum (NAS) message that corresponds to the selected core network and includes an attach request message; and transmitting the NAS message to the selected core network.

The method may further include receiving a Random Access Response (RRC) connection setup complete message from the UE, and transmitting an initial UE message to the selected core network, wherein the receiving the NAS message may include receiving the NAS message from the UE through the RRC connection setup complete message, and the transmitting the NAS message may include transmitting the NAS message to the selected core network through the initial UE message.

In accordance with an aspect of the disclosure, there is provided a User Equipment (UE) in a wireless communication system supporting a plurality of communication systems, the UE including: a transceiver; and at least one processor, wherein the at least one processor may be configured to: control the transceiver to receive, from a base station (BS), first core information related to a plurality of core networks, select a core network of the plurality of core networks based on the first core information, control the transceiver to transmit, to the BS, second core information related to the selected core network, and establish a Signaling Radio Bearer (SRB) between the UE and the selected core network, based on the second core information.

The at least one processor may be further configured to control the transceiver to receive the first core information from the BS through at least one of a System Information Block (SIB), a Master Information Block (MIB), a Random Access Response (RAR), and a paging message.

The second core information may be transmitted to the BS through a Radio Resource Control (RRC) message.

The at least one processor may be further configured to control the transceiver to transmit a Non-Access-Stratum (NAS) message that corresponds to the selected core network, and includes an attach request message.

The least one processor may be further configured to control the transceiver to transmit the NAS message through an RRC connection setup complete message.

In accordance with an aspect of the disclosure, there is provided a base station (BS) in a wireless communication system supporting a plurality of communication systems, the BS including: a transceiver; and at least one processor, wherein the at least one processor is configured to: control the transceiver to transmit, to a User Equipment (UE), first core information related to a plurality of core networks, control the transceiver to receive, from the UE, second core information related to a core network selected from the plurality of core networks, and establish a Signaling Radio Bearer (SRB) between the UE and the selected core network, based on the second core information.

The at least one processor may be further configured to control the transceiver to transmit the first core information to the UE through at least one of a System Information Block (SIB), a Master Information Block (MIB), a Random Access Response (RAR), and a paging message.

The at least one processor may be further configured to control the transceiver to receive second core information from the UE through a Radio Resource Control (RRC) message.

The at least one processor may be further configured to control the transceiver to receive, from the UE, a Non-Access-Stratum (NAS) message corresponding to the selected core network and to transmit the received NAS message to the selected core network, and wherein the NAS message may include an attach request message.

The at least one processor may be further configured to control the transceiver to receive the NAS message, from the UE, through an RRC connection setup complete message (Msg5), and to transmit the received NAS message to the selected core network through an initial UE message.

In accordance with an aspect of the disclosure, there is provided a method for a user equipment in a wireless communication system, the method including: selecting a core network from a plurality of core networks, based on first core information about the plurality of core networks; transmitting, to a base station, second core information about the selected core network; in response to the second core information including information about a fifth generation (5G) core network that the user equipment is attempting to access, and the base station being connected to the 5G core network, receiving a Radio Resource Control (RRC) connection reconfiguration message from the base station when the base station reestablishes a Signaling Radio Bearer (SRB) corresponding a fourth generation (4G) core network into an SRB corresponding to the 5G core network, and in response to the second core information including the information about the 5G core network that the user equipment is attempting to access, and the base station not being connected to the 5G core network, receiving an RRC connection release message from the base station.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a flowchart illustrating a method by which a UE establishes a signaling radio bearer in a wireless communication system supporting a plurality of communication systems according to various embodiments;

FIG. 2 is a flowchart illustrating a method in which an evolved Node B (eNB) establishes a signaling radio bearer in a wireless communication system supporting a plurality of communication systems according to various embodiments;

FIG. 3 is a flowchart illustrating a method by which the UE performs triggering and establishes a signaling radio bearer in a wireless communication system supporting a plurality of communication systems according to various embodiments;

FIG. 4 is a flowchart illustrating a method by which the UE performs triggering and establishes a signaling radio bearer in a wireless communication system supporting a plurality of communication systems according to various embodiments;

FIGS. 5A and 5B are flowcharts illustrating a method by which the core network performs triggering and establishes a signaling radio bearer in a wireless communication system supporting a plurality of communication systems according to various embodiments;

FIG. 6 is a flowchart illustrating a method by which the core network performs triggering and establishes a signaling radio bearer in a wireless communication system supporting a plurality of communication systems according to various embodiments;

FIG. 7 is a flowchart illustrating an inter-system handover method between a source eNB (non-eLTE eNB) and a target eNB (eLTE eNB interworking with a 5G core network) in a wireless communication system supporting a plurality of communication systems according to various embodiments;

FIGS. 8A and 8B are flowcharts illustrating an inter-system handover method between the source eNB (non-eLTE eNB) and the target eNB (eLTE eNB interworking with the 5G core network) in a wireless communication system supporting a plurality of communication systems according to various embodiments;

FIG. 9 is a conceptual diagram illustrating a method of identifying a core network which can interwork with the UE in a wireless communication system supporting a plurality of communication systems according to various embodiments;

FIGS. 10, 11, 12A, and 12B are flowcharts illustrating various examples of a method of selecting one of a plurality of core networks according to a core network interworking with the UE and performing an initial access procedure in a wireless communication system supporting a plurality of communication systems according to various embodiments;

FIG. 13 is a block diagram of the UE capable of establishing a signaling radio bearer in a wireless communication system supporting a plurality of communication systems according to various embodiments; and

FIG. 14 is a block diagram of the eNB capable of establishing a signaling radio bearer in a wireless communication system supporting a plurality of communication systems according to various embodiments.

### DETAILED DESCRIPTION

Hereinafter, embodiments are described in detail with reference to the accompanying drawings.

In the following description, like drawing reference numerals are used for like elements, even in different drawings. In the drawings, some elements may be exaggerated, omitted, or schematically illustrated, and the size of each element may not entirely reflect the actual size. The matters defined in the description, such as detailed construction and elements, are provided to assist in a comprehensive understanding of the embodiments. However, it is apparent that the embodiments can be practiced without those specifically defined matters. Also, well-known functions or constructions are not described in detail since they would obscure the description with unnecessary detail.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements.

Here, it will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

And each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used herein, the “unit” or “module” refers to a software element or a hardware element, such as a Field Programmable Gate Array (FPGA) or an Application Specific Integrated Circuit (ASIC), which performs a predetermined function. However, the “unit” or “module” does not always have a meaning limited to software or hardware. The “unit” or “module” may be constructed either to be stored in an addressable storage medium or to execute one or more processors. Therefore, the “unit” or “module” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” or “module” may be either combined into a smaller number of elements, “unit”, or “module” or divided into a larger number of elements, “unit”, or “module”. Moreover, the elements and “units” or “modules” may be implemented to reproduce one or more CPUs within a device or a security multimedia card.

Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples.

The specific terms used herein are provided for ease of understanding the disclosure, and such specific terms may be changed into other forms without departing from the spirit and scope of the disclosure.

First, the terms used in this specification will be defined.

The term “radio bearer” in this specification may include a Data Radio Bearer (DRB) and a Signaling Radio Bearer (SRB).

For example, a DRB provided by a radio interface between a UE and an evolved Node B (eNB) may be a path through which data of a user plane is transmitted, and an SRB may be a path through which data of a control plane such as Non-Access-Stratum (NAS) control messages are transmitted on Radio Resource Control (RRC) layers.

In this specification, a wireless communication system supported by a network in which a plurality of communication systems interworks with each other may support multi-radio access technology (RAT) interworking. In this specification, an inter-system supporting different communication networks may be largely divided into a UE, a radio access network and a plurality of Core Networks (CNs).

In this specification, the UE may be an integrated UE supporting all of 4G radio access technology (e.g., Evolved Universal Terrestrial Radio Access (E-UTRA)), radio access technology evolved from 4G (evolved E-UTRA), and 5G radio access technology (New Radio (NR)) which are evolved from 4G.

In this specification, the radio access network may support a plurality of Radio Access Technologies (RATs) and multi-RAT interworking.

For example, the radio access technology may be a new Radio Access Network (RAN) all of 4G radio access technology (e.g., E-UTRA), radio access technology evolved from 4G (e.g., E-UTRA), and 5G radio access technology (e.g., New Radio (NR)) which have evolved from 4G.

In this specification, a radio access network, an eNB, and a network node may be used to mean the same thing, and the eNB may include a 5G eNB (new radio base station (gNB)) using 5G radio access technology (New Radio (NR)), a 4G eNB (LTE-eNB) using 4G radio access technology (E-UTRA), and an eNB (eLTE eNB) using radio access technology evolved from 4G (evolved E-UTRA). Further, the eNB (eLTE eNB) may simultaneously support the 4G radio access technology and the 5G radio access technology and may access a 4G core network and a 5G core network.

In this specification, a plurality of core networks may include a 4G core network supporting radio access technology evolved from 4G and a 5G core network supporting 5G radio access technology.

For example, the 4G core network may be an Evolved Packet Core (EPC), and the 5G core network may be a 5G Core (5GC).

In this specification, a signaling radio bearer corresponding to a core network may include at least one of an Long-Term Evolution (LTE)—Packet Data Convergence Protocol (PDCP) version SRB corresponding to the 4G core network and an New Radio—PDCP (NR-PDCP) version SRB corresponding to the 5G core network.

The terms “LTE-PDCP version SRB” and “default SRB” disclosed in the disclosure may be understood as having the same meaning in this specification and the terms “LTE-PDCP version DRB” and “default DRB” may be interchangeably used in this specification.

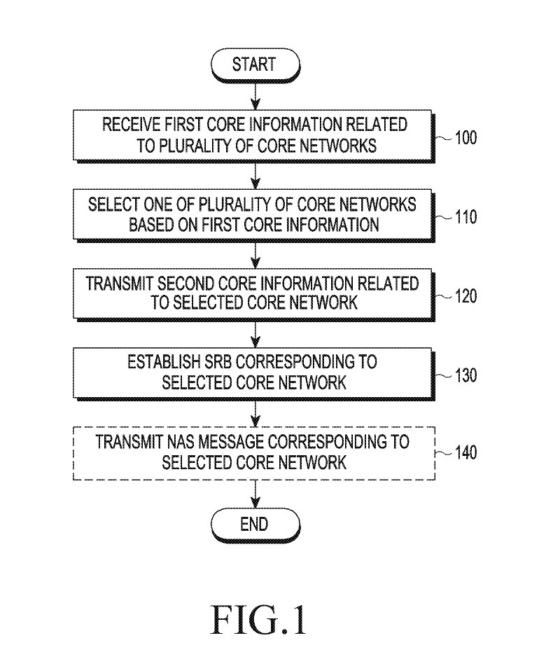

FIG. 1 is a flowchart illustrating a method by which a UE establishes a signaling radio bearer in a wireless communication system supporting a plurality of communication systems according to various embodiments.

In operation 100, the UE may receive first core information related to a plurality of core networks from an eNB.

The first core information according to various embodiments may include information related to one or more core networks associated with the eNB.

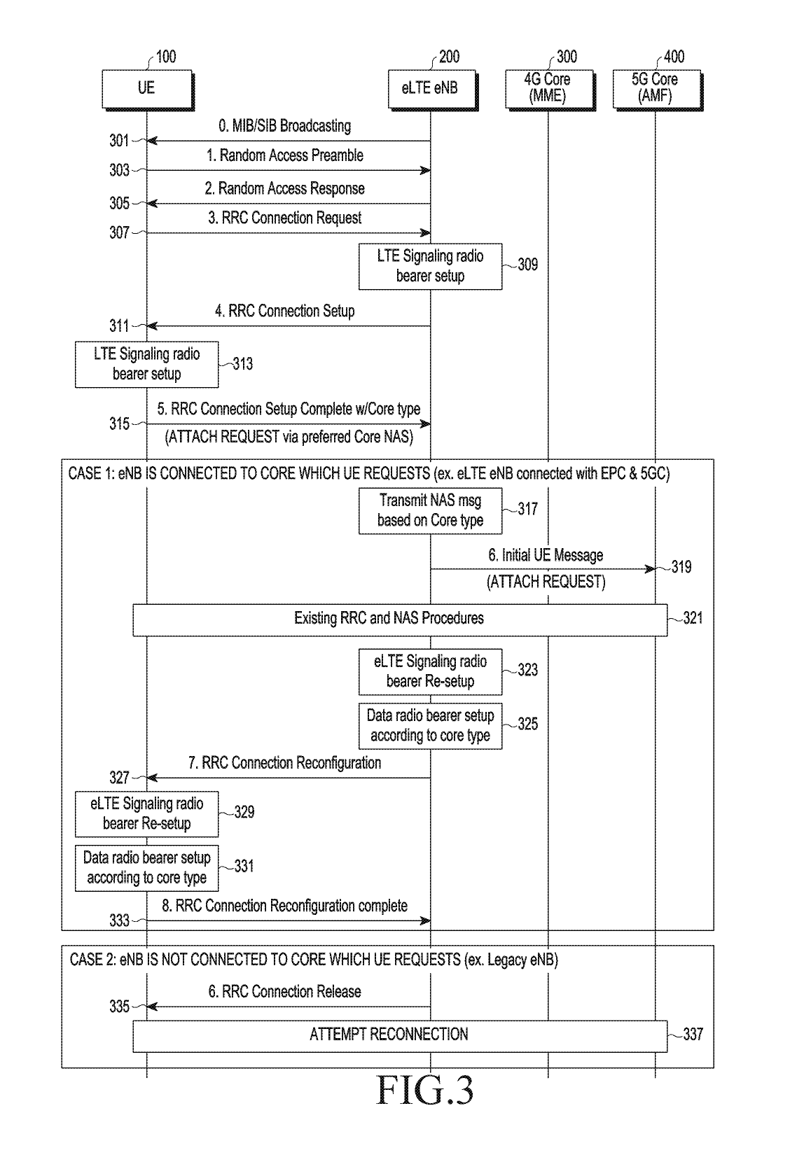

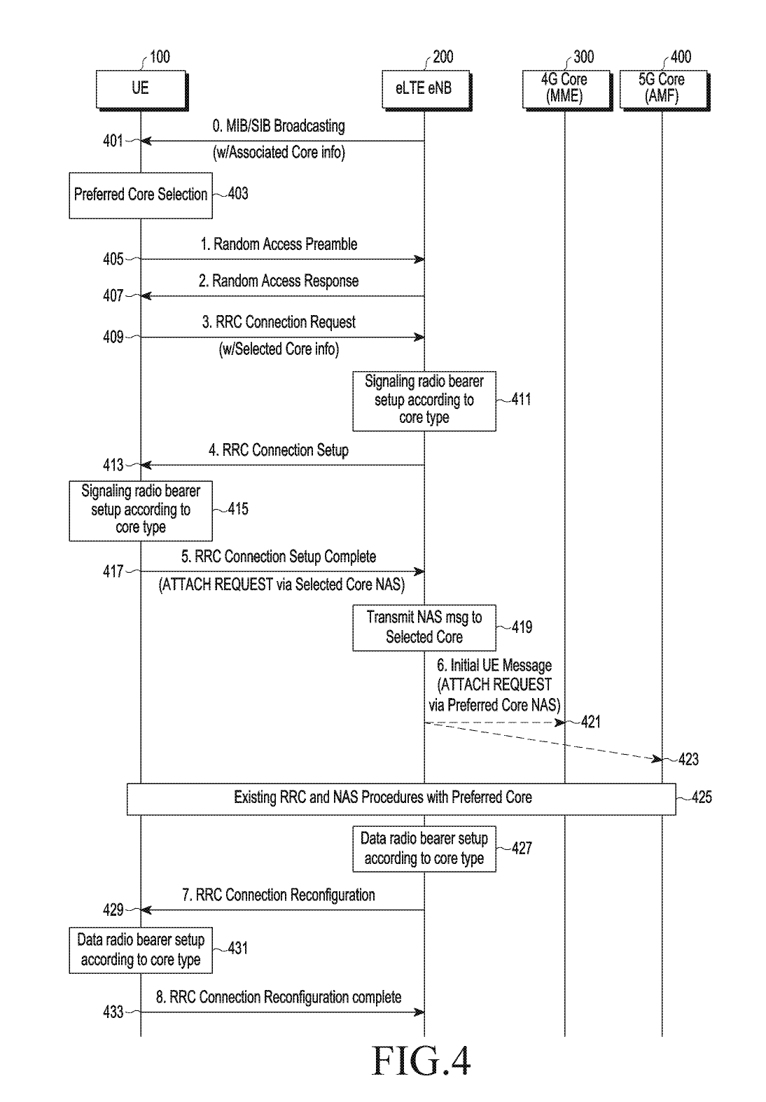

The first core information according to various embodiments may be received through at least one of a System Information Block (SIB), a Master Information Block (MIB), and a Random Access Response (RAR). This will be described with reference to FIGS. 3 and 4.

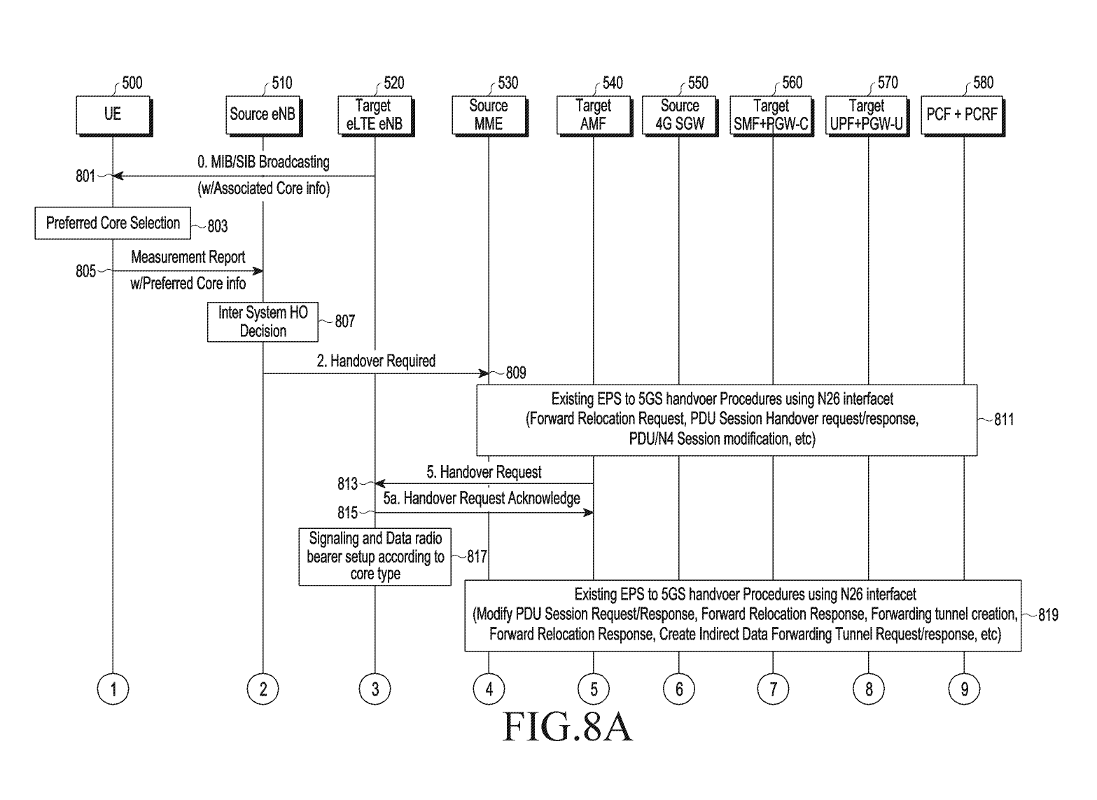

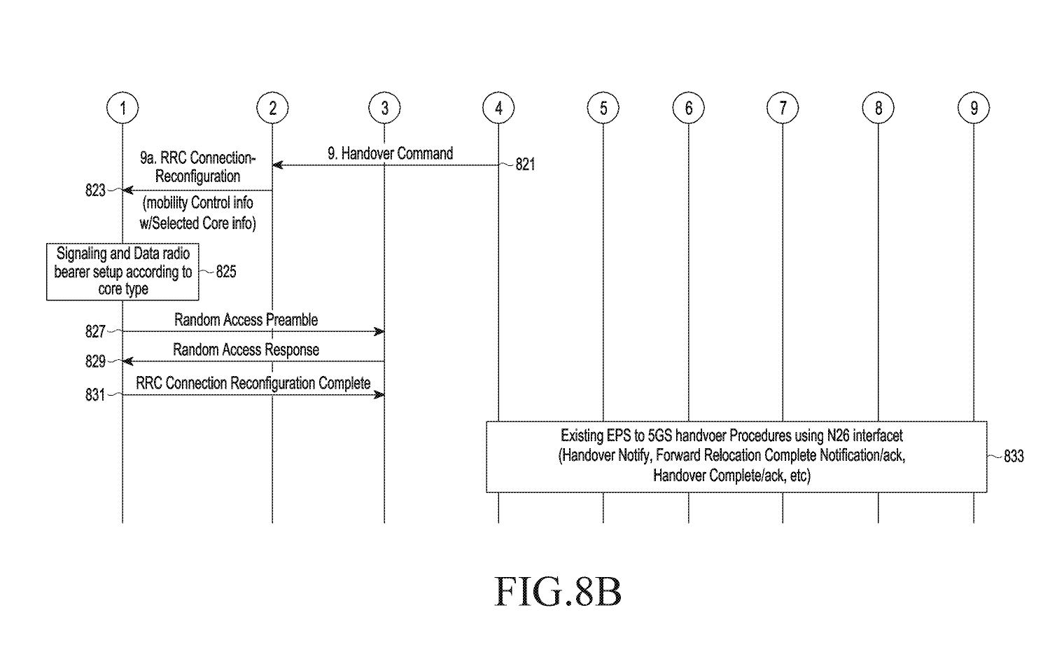

The first core information according to various embodiments may be received from a target eNB (target eLTE eNB) to which the UE desires to perform handover through a System Information Block (SIB) or a Master Information Block (MIB). This will be described with reference to FIG. 8.

The first core information according to various embodiments may include information on a core network triggering a call.

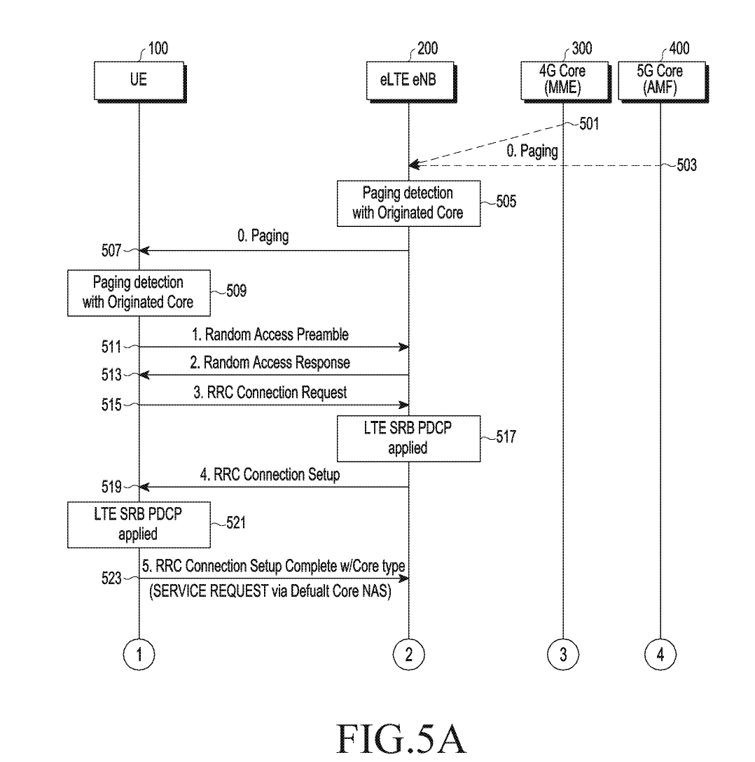

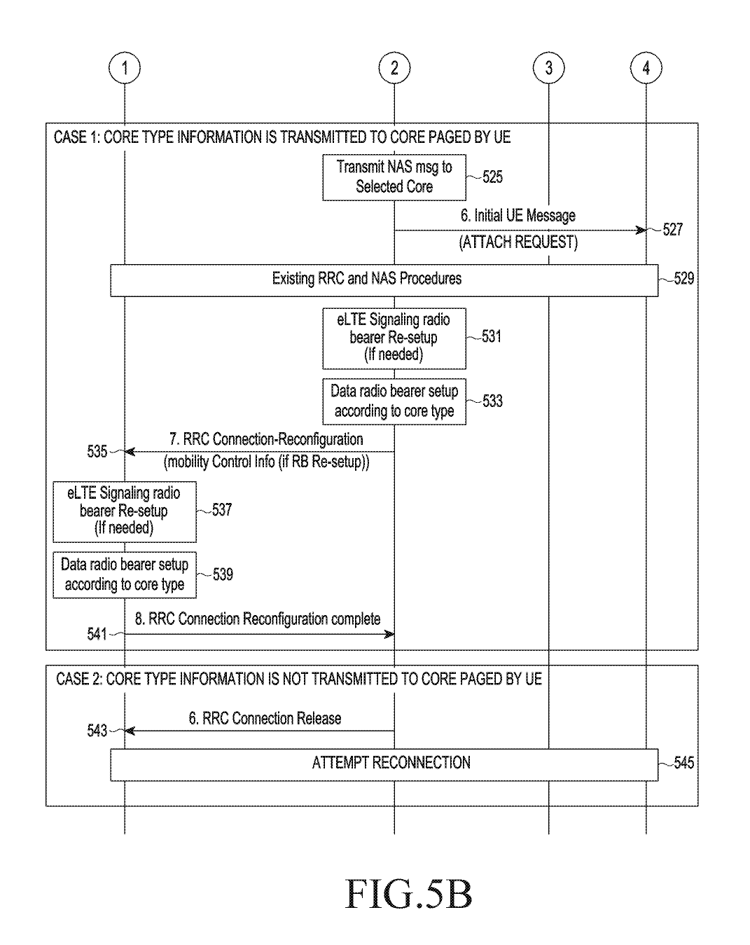

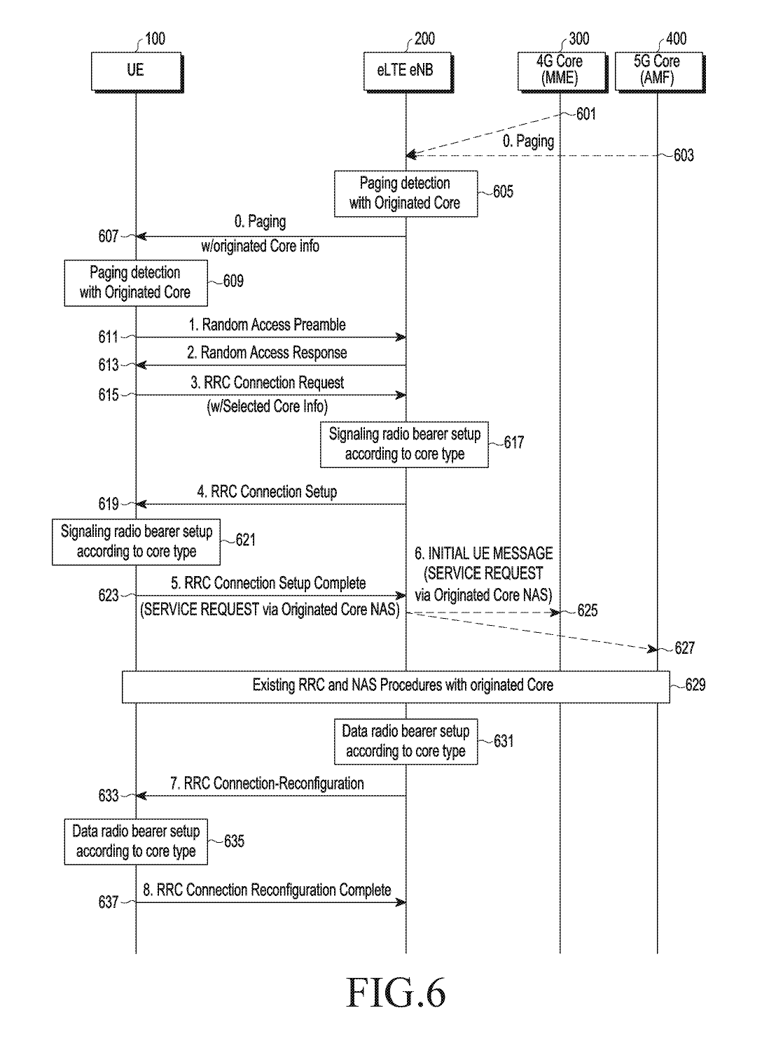

The first core information according to various embodiments may be received from the eNB through a paging message. This will be described with reference to FIGS. 5 and 6.

In operation 110, the UE may select one of a plurality of core networks based on the first core information.

The plurality of core networks according to various embodiments may include a 4G core network supporting radio access technology evolved from 4G and a 5G core network supporting 5G radio access technology.

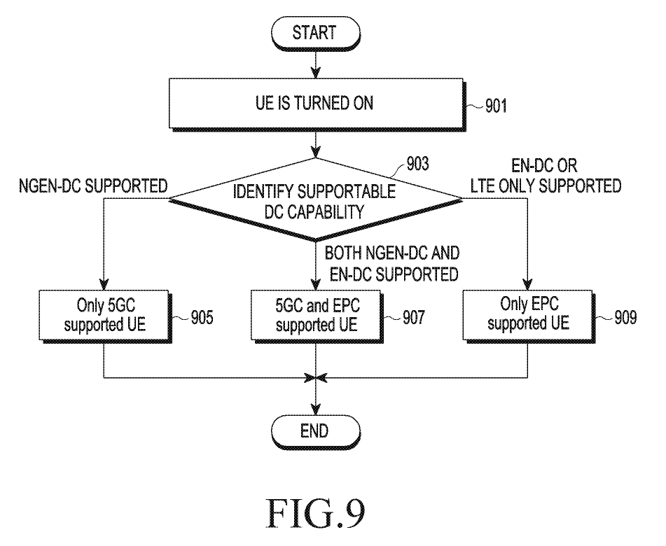

One of the plurality of core networks according to various embodiments may be selected by the UE based on at least one piece of information on a Dual Connectivity (DC) development option and a service type, and core information related to a core network connected to the eNB. This will be described with reference to FIGS. 9 to 11 and FIGS. 12A and 12B.

In operation 120, the UE may transmit second core information related to the selected core network to the eNB.

The second core network according to various embodiments may include information related to a core network which the UE desires to access.

The second core information according to various embodiments may be transmitted to the eNB through an RRC message.

For example, the second core information may be transmitted to the eNB, through an RRC connection request message (Msg3). This will be described with reference to FIGS. 4 and 6.

Further, the second core information may be transmitted to the eNB through an RRC connection setup complete message (Msg5). This will be described with reference to FIG. 3 and FIGS. 5A and 5B.

In addition, the second core information may be transmitted to the eNB through a measurement report message. This will be described with reference to FIGS. 8A and 8B.

In operation 130, the UE may establish a signaling radio bearer corresponding to the selected core network.

The signal bearer according to various embodiments may be a path through which data of a control plane such as an NAS control message is transmitted from a wireless interface between the UE and the eNB on RRC layers.

A PDCP version of the signal radio bearer according to various embodiments may include an LTE-PDCP version or an NR-PDCP version in accordance with Radio Access Technology (RAT).

For example, the signaling radio bearer corresponding to the core network may include at least one of an SRB of the LTE-PDCP version corresponding to the 4G core network or an SRB of the NR-PDCP version corresponding to the 5G core network.

The UE according to various embodiments may reestablish an SRB corresponding to the core network selected by the UE through an RRC connection reconfiguration procedure after generating a default SRB through an RRC connection establishment procedure.

For example, after the default SRB (the SRB of the LTE-PDCP version) is generated through the RRC connection establishment procedure, the second core information may be transmitted through an RRC connection setup complete message (Msg5) which is a one way message transmitted to the eNB in operation 120.

Meanwhile, the operations performed in FIG. 1 may be executed in parallel. For example, operation 120 of FIG. 1 in which the UE transmits the second core information related to the selected core network through the RRC connection setup complete message (Msg5) may be performed in parallel to operation 140 in which the UE transmits an NAS message corresponding to the selected core network through the RRC connection setup complete message (Msg5). In this case, operation 130 in which the UE establishes the signaling radio bearer corresponding to the core network selected in operation 110 may be performed after operation 140 in which the UE transmits the NAS message corresponding to the selected core network.

After transmitting the second core information and the NAS message through the RRC connection setup complete message (Msg5) in operations 120 and 140, the UE according to various embodiments may perform different operations according to whether the eNB is connected to a core network included in the second core information.

For example, an embodiment in which the eNB is connected to the core network included in the second core information may cover the case in which the first core information matches the second core information. This will be described with reference to FIGS. 5A to 5B.

For example, when the second core information includes information related to a 5G core network which the UE desires to access and the eNB is connected to the 5G core network, the UE may reestablishes the SRB of the NR-PDCP version corresponding to the 5G core network through the RRC connection reconfiguration procedure in operation 130.

On the other hand, when the eNB receives the second core information related to the 5G core network which the UE desires to access through the RRC connection setup complete message (Msg5) but the eNB is not connected to the 5G core network, the eNB may perform RRC connection release on the UE and the UE may attempt a reconnection. This will be described with reference to FIG. 3 and FIGS. 5A to 5B.

The UE according to various embodiments may establish an SRB corresponding to the core network selected by the UE through the RRC connection establishment procedure.

For example, when the second core information transmitted in operation 120 is transmitted through the RRC connection request message (Msg3) transmitted to the eNB, the UE may generate the SRB corresponding to the core network selected in operation 110 through the RRC connection establishment procedure in operation 130. This will be described with reference to FIGS. 4 and 6.

For example, when the eNB supports Dual Connectivity (DC) and thus simultaneously interworks with the EPC and the 5GC, the UE may establish the (default) SRB of the LTE-PDCP version corresponding to the 4G core network if the core network selected by the UE is the 4G core network. and the UE may establish the SRB of the NR-PDCP version corresponding to the 5G core network through the RRC connection establishment procedure without establishing the default SRB if the core network selected by the UE is the 5G core network.

The UE according to various embodiments may perform inter-system handover between a source eNB supporting only the 4G radio access technology and a target eNB interworking with both the 4G radio access technology and the 5G radio access technology, thereby performing handover from the 4G core network to the 5G core network.

The UE according to various embodiments may establish the SRB corresponding to the core network selected by the UE through the handover procedure.

The UE according to various embodiments may establish the default SRB and the default DRB corresponding to the 4G core network through the handover procedure between the source eNB and the target eNB. When the UE can interwork with the core network which the UE desires to access, the UE may reestablish the SRB and the DRB corresponding to the core network selected by the UE by further performing the handover procedure.

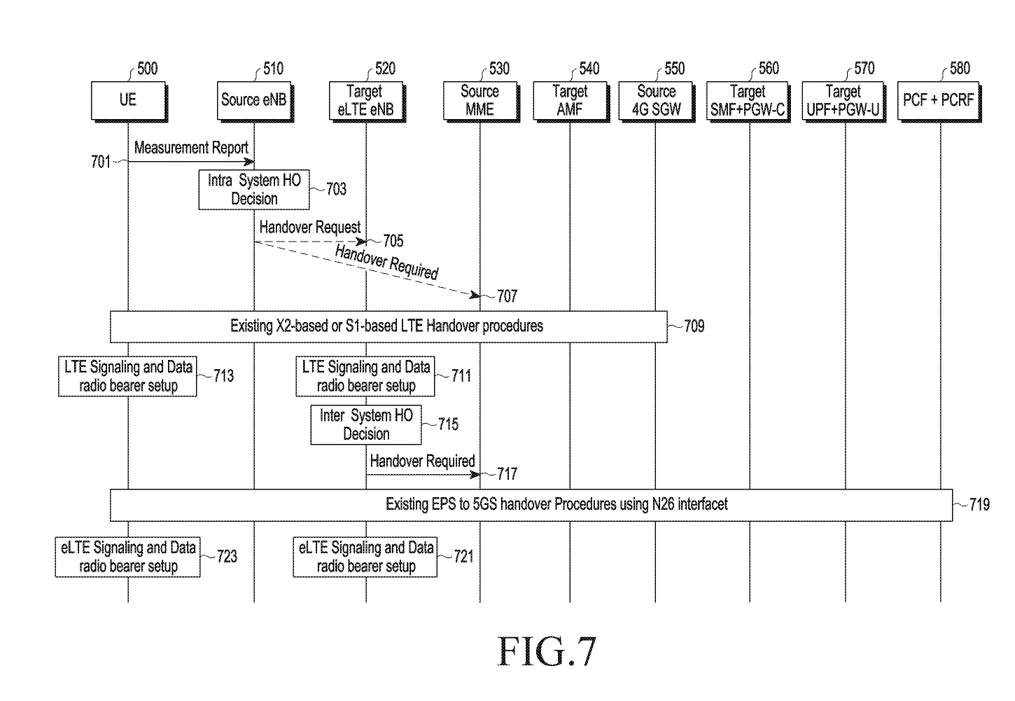

For example, the UE may establish the default SRB and the default DRB corresponding to the 4G core network through the handover procedure between the source eNB and the target eNB. When the UE can interwork with the 5G core network, the UE may reestablish the SRB and the DRB of the NR-PDCP version corresponding to the 5G core network by further performing the handover procedure. This will be described with reference to FIG. 7.

The UE according to various embodiments may transmit second core information to the eNB through the measurement report message in operation 120 and may establish the SRB and the DRB corresponding to the core network selected by the UE through the handover procedure between the source eNB and the target eNB in operation 130. The UE may perform the handover procedure when the SRB and the DRB corresponding to the selected core network are different from the default SRB and the default DRB.

For example, when the handover from the 4G core network to the 5G core network is performed, if the core network which the UE desires to access is the 5G core network, the UE may establish the SRB and the DRB of the NR-PDCP version corresponding to the 5G core network through the handover procedure without establishing the default SRB nor the default DRB. This will be described with reference to FIGS. 8A and 8B.

As described above, in a wireless communication system supporting a plurality of communication systems according to various embodiments in FIGS. 4 and 6 and FIGS. 8A and 8B, the UE can establish the SRB corresponding to the core network selected by the UE without establishing the default SRB in the RRC connection establishment procedure by transmitting information on the core network which the UE desires to access through the RRC connection request message (Msg3) in an initial access procedure (e.g., in attach or idle to active), thereby reducing initial access latency and an unnecessary processing procedure in the eNB and the core network.

In operation 140, the UE may transmit a Non-Access Stratum (NAS) message corresponding to the selected core network. The NAS message may be used to communicate through a NAS that allows to manage the establishment of communication sessions and maintain continuous communications between the UE and the selected core network when the UE moves, unlike Access Stratum that supports communication between the UE and the radio network. Examples of NAS messages may include Attach messages, Authentication Messages, Service Requests.

The RCC connection according to various embodiments may be established between RRC layers of the UE and the eNB and the NAS message may be transmitted through the RRC message in the RRC connection.

For example, the NAS message may be transmitted through the RRC connection setup complete message (Msg5) transmitted to the eNB.

The NAS message according to various embodiments may include an attach request message. The UE may need to register with the selected core network to receive services that may require registration, and this registration may refer to network attachment. The UE may initiate the attach procedure by transmitting the attach request message to the eNB.

For example, the attach request message may include a UE ID corresponding to an International Mobile Subscriber Identity (IMSI) to make a request for network access and network capability supported by the UE.

As described above, since the NAS message may be transmitted through the RRC connection setup complete message transmitted to the eNB, the attach request message included in the NAS message may be transmitted to the eNB through a dedicated NAS information field of the RRC connection setup complete message (Msg5).

Operations performed by a module, a programming module, or other elements according to various embodiments may be executed sequentially, in parallel, repeatedly, or in a heuristic manner. At least some operations may be executed according to another sequence, may be omitted, or may further include other operations.

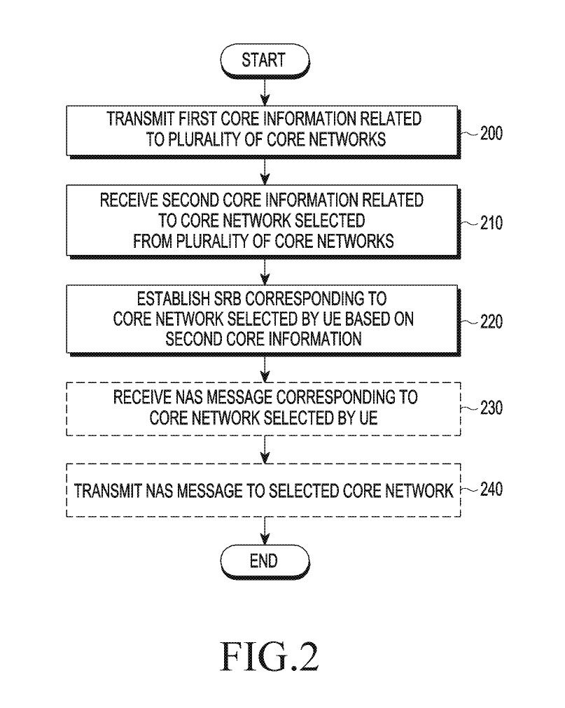

FIG. 2 is a flowchart illustrating a method in which the eNB establishes a signaling radio bearer in a wireless communication system supporting a plurality of communication systems according to various embodiments.

In operation 200, the eNB may transmit first core information related to a plurality of core networks to the UE.

For example, the first core information may include at least one piece of information related to one or more core networks associated with the eNB and information on a core network triggering a call.

Further, the first core information may be transmitted through at least one of a System Information Block (SIB), a Master Information Block (MIB), a Random Access Response (RAR), and a paging message.

For example, the eNB may receive the first core information through the paging message transmitted from the core network triggering the call and may transmit the received first core information to the UE through the paging message.

In operation 210, the eNB may receive, from the UE, second core information related to the core network selected from among the plurality of core networks.

The second core information according to various embodiments may include information related to a core network which the UE desires to access.

The second core information according to various embodiments may be received from the UE through the RRC message.

For example, the second core information may be transmitted through at least one of the RRC connection request message (Msg3), the RRC connection setup complete message (Msg5), and the measurement report message, received from the UE.

In operation 220, the eNB may establish a signaling radio bearer corresponding to the core network selected by the UE based on the second core information received in operation 210.

The eNB according to various embodiments may reestablish an SRB corresponding to the core network selected by the UE based on the second core information received in operation 210 after generating the default SRB through the RRC connection establishment procedure.

For example, after the default SRB (the SRB of the LTE-PDCP version) is generated through the RRC connection establishment procedure, the second core information may be received through the RRC connection setup complete message (Msg5) which is a one way message received from the UE.

Meanwhile, the operations performed in FIG. 2 may be executed in parallel. For example, operation 210 of FIG. 2 in which the eNB receives the second core information through the RRC connection setup complete message (Msg5) may be performed in parallel to operation 230 in which the eNB receives an NAS message corresponding to the selected core network through the RRC connection setup complete message (Msg5). In this case, operation 220 in which the eNB establishes the signaling radio bearer corresponding to the core network selected by the UE may be performed after operation 230 in which the eNB receives the NAS message corresponding to the core network selected by the UE and operation 240 in which the eNB transmits the NAS message to the selected core network.

This will be described with reference to FIG. 3 and FIGS. 5A to 5B.

After receiving the second core information and the NAS message through the RRC connection setup complete message (Msg5) in operations 210 and 230, the eNB according to various embodiments may perform different operations according to whether the eNB is connected to a core network included in the second core information.

For example, an embodiment in which the eNB is connected to the core network included in the second core information may cover the case in which the first core information matches the second core information. This will be described with reference to FIGS. 5A to 5B.

For example, when the second core information received in operation 210 through the RRC connection setup complete message (Msg5) includes information related to the 5G core network which the UE desires to access and the eNB is connected to the 5G core network, the eNB may transmit the NAS message received in operations 210 and 230 through the RRC connection setup complete message (Msg5) to the selected core network in operation 240, and may reestablish the SRB of the NR-PDCP version corresponding to the 5G core network and establish the DRB of the NR-PDCP version through the RRC connection reconfiguration procedure.

On the other hand, when the eNB is not connected to the 5G core network which the UE desires to access, the eNB may make a request for RRC connection release to the UE and the UE may attempt a reconnection. This will be described with reference to FIG. 3 and FIGS. 5A to 5B.

The eNB according to various embodiments may establish an SRB corresponding to the core network selected by the UE through the RRC connection establishment procedure.

For example, when the second core information received in operation 210 is transmitted through the RRC connection request message (Msg3) transmitted to the eNB, the UE may generate the SRB corresponding to the core network selected by the UE through the RRC connection establishment procedure in operation 220. This will be described with reference to FIGS. 4 and 6.

For example, when the eNB supports Dual Connectivity (DC) and thus simultaneously interworks with the EPC and the 5GC, the eNB may establish the SRB (default SRB) of the LTE-PDCP version corresponding to the 4G core network if the selected core network is the 4G core network, and may establish the SRB of the NR-PDCP version corresponding to the 5G core network through the RRC connection establishment procedure without establishing the default SRB if the selected core network is the 5G core network.

The eNB according to various embodiments may perform inter-system handover between a source eNB supporting only the 4G radio access technology and a target eNB interworking with both the 4G radio access technology and the 5G radio access technology, thereby performing handover from the 4G core network to the 5G core network.

The target eNB according to various embodiments may establish the SRB corresponding to the core network selected by the UE through the handover procedure.

The target eNB according to various embodiments may establish the default SRB and the default DRB corresponding to the 4G core network through the handover procedure, and when the target eNB can interwork with the core network which the UE desires to access, the target eNB may reestablish the SRB and the DRB corresponding to the core network selected by the UE by further performing the handover procedure.

For example, the target eNB may establish the default SRB and the default DRB corresponding to the 4G core network through the handover procedure with the source eNB, and when the target eNB can interwork with the 5G core network, the target eNB may reestablish the SRB and the DRB of the NR-PDCP version corresponding to the 5G core network by further performing the handover procedure. This will be described with reference to FIG. 7.

When eNB according to various embodiments may receive the second core information through the measurement report message which the source eNB receives in operation 210, the target eNB may establish the SRB and the DRB corresponding to the core network selected by the UE based on the second core information.

For example, when the handover from the 4G core network to the 5G core network is performed, if the selected core network is the 5G core network, the target eNB may establish the SRB and the DRB of the NR-PDCP version corresponding to the 5G core network through the handover procedure without establishing the default SRB nor the default DRB. This will be described with reference to FIGS. 8A and 8B.

As described above, in a wireless communication system supporting a plurality of communication systems according to various embodiments in FIGS. 4, 6, and 8A to 8B, the eNB may establish the SRB and the DRB corresponding to the core network selected by the UE without establishing the default SRB nor the DRB in initial access procedure (e.g., in attach or idle to active), thereby reducing initial delay latency and an unnecessary processing procedure in the eNB and the core network.

In operation 230, the eNB may receive, from the UE, the NAS message corresponding to the core network selected by the UE.

The NAS message according to various embodiments may be transferred from the NAS layer of the UE to the NAS layer of the core network (an MME of the 4G core network or an AMF of the 5G core network).

For example, for transmission of the NAS message, an Evolved Packet System (EPS) Connection Management (ECM) connection should be established between the NAS layer of the UE and the NAS layer of the core network (the MME of the 4G core network or the AMF of the 5G core network), and the ECM connection may include an RRC connection established between the UE and the eNB and an S1 signaling connection between the eNB and the core network (the MME of the 4G core network or the AMF of the 5G core network).

For example, the NAS message may be transmitted through the RRC message in the RRC connection and through an S1 Application Protocol (S1AP) message (initial UE message) in the S1 signaling connection.

For example, the NAS message may be transmitted to the eNB through the RRC connection setup complete message (Msg5).

Further, the NAS message may be transmitted through the initial UE message which is the S1AP message transmitted from the eNB to the core network.

The NAS message according to various embodiments may include an attach request message.

For example, since the NAS message may be transmitted to the eNB through the RRC connection setup complete message (Msg5), the attach request message included in the NAS message may be transmitted to the eNB through a dedicated NAS information field of the RRC connection setup complete message (Msg5).

In operation 240, the eNB may transmit the NAS message received in operation 230 to the selected core network.

The NAS message according to various embodiments may be transmitted through S1AP message (initial UE message) transmitted from the eNB to the selected core network.

For example, the attach request message included in the NAS message may be transmitted to the core network selected by the UE through an NAS-protocol data unit (PDU) field of the S1AP message (initial UE message).

FIGS. 3 to 4 illustrate a method by which the UE performs an (mobile originated) initial access procedure on the eNB and the core network by triggering a call in a wireless communication system supporting a plurality of communication systems according to various embodiments.

FIG. 3 is a flowchart illustrating a method by which the UE performs triggering and establishes a Signaling Radio Bearer (SRB) in a wireless communication system supporting a plurality of communication systems according to various embodiments.

The wireless communication system may includes a user equipment (UE) 100, an eNB 200, a 4G core network (including a Mobility Management Entity (MME)) 300, and a 5G core network (including an Access and Mobility Management Function (AMF)) 400.

As illustrated in FIG. 3, the UE 100 and the eNB 200 may establish the (default) SRB of the LTE-PDCP version corresponding to the 4G core network 300 through the RRC connection establishment procedure in initial access, and the UE 100 may transmit an NAS message including information related to the core network which the UE 100 desires to access and an attach request message to the eNB 200 in one way through the RRC connection setup complete message (Msg5).

Further, when the core network which the UE 100 desires to access is the 5G core network 400, the UE 100 and the eNB 200 may reestablish the SRB of the NR-PDCP version corresponding to the 5G core network 400 which the UE 100 desires to access and establish the DRB of the NR-PDCP version corresponding to the 5G core network 400 through the RRC connection reconfiguration procedure.

In operation 301, the UE 100 may receive a Master Information Block (MIB) or a System Information Block (SIB) broadcasted from the eNB 200.

The UE 100 may transmit a random access preamble to the eNB 200 in operation 303, and may receive a Random Access Response (RAR) message from the eNB 200 and attempt a random access procedure in operation 305.

In operation 307, the UE 100 may transmit an RRC connection request message (Msg3) to the eNB 200.

In operation 309, the eNB 200 may establish the SRB (default SRB) of the LTE-PDCP version corresponding to the 4G core network 300.

In operation 311, the UE 100 may receive an RRC connection setup message (Msg4) from the eNB 200.

In operation 313, the UE 100 may establish the SRB (default SRB) of the LTE-PDCP version corresponding to the 4G core network 300.

In operation 315, the UE 100 may transmit core information (e.g., second core information) related to the core network which the UE 100 desires to access and an NAS message corresponding to the core network which the UE 100 desires to access through an RRC connection setup complete message (Msg5).

For example, the core information related to the core network which the UE 100 desires to access may be the same as the second core information described in FIG. 1.

For example, the NAS message may include an attach request message.

In the wireless communication system according to various embodiments, the UE 100 and the eNB 200 according to various embodiments may perform operations 317 to 335 or operations 337 to 339 according to whether the eNB 200 is connected to the core network which the UE 100 desires to access.

For example, when the eNB 200 is connected to the 5G core network 400 which the UE 100 desires to access, the eNB 200 may transmit the NAS message received in operation 315 to the 5G core network in operation 317. More specifically, the eNB 200 may transmit the NAS message including the attach request message to the 5G core network 400 through the initial UE message in operation 319.

In operation 321, a radio bearer may be established between the NAS layer of the UE and the NAS layer of the 5G core network 400 in the wireless communication system.

For example, when the AMF of the 5G core network 400 or the MME of the 4G core network 300 receives the initial UE message from the eNB 200, the signaling connection may be established between the eNB 200 and the core network.

In operation 323, the eNB 200 may reestablish the SRB (default SRB) of the LTE-PDCP version corresponding to the 4G core network 300 established in operation 309 to be the SRB of the NR-PDCP version corresponding to the 5G core network 400 which the UE desires to access.

In operation 325, the eNB 200 may establish the DRB of the NR-PDCP version corresponding to the 5G core network 400 which the UE 100 desires to access.

In operation 327, the eNB 200 may transmit an RRC connection reconfiguration message to the UE 100.

In operation 329, the UE 100 may reestablish the SRB (default SRB) of the LTE-PDCP version corresponding to the 4G core network 300 established in operation 313 to be the SRB of the NR-PDCP version corresponding to the 5G core network 400 which the UE 100 desires to access.

In operation 331, the UE 100 may establish the DRB of the NR-PDCP version corresponding to the 5G core network 400 which the UE 100 desires to access.

In operation 333, the UE may transmit an RRC connection reconfiguration complete message to the eNB 200.

For example, when the eNB 200 is not connected to the 5G core network 400 which the UE 100 desires to access, the eNB 200 may make a request for RRC connection release to the UE 100 and the UE 100 may attempt a reconnection in operation 337.

FIG. 4 is a flowchart illustrating a method by which the UE 100 performs triggering and establishes a Signaling Radio Bearer (SRB) in a wireless communication system supporting a plurality of communication systems according to various embodiments.

As illustrated in FIG. 4, the UE 100 may receive, from the eNB 200, first core information related to the core network associated with the eNB 200, select the core network which the UE desires to access based on the first core information. The UE 100 may transmit second core information related to the selected core network, to the eNB through an RRC connection request message (Msg3).

Further, the UE 100 and the eNB 200 may establish an SRB corresponding to the selected core network through an RRC connection establishment procedure in initial access.

The UE 100 may transmit an NAS message including an attach request message to the eNB 200 through an RRC connection setup complete message (Msg5) and the eNB 200 may transmit the NAS message to the selected core network.

The UE 100 and the eNB 200 may establish the DRB corresponding to the core network which the UE 100 desires to access through an RRC connection reconfiguration procedure.

In operation 401, the UE 100 may receive, from the eNB 200, first core information which is information related to one or more core networks associated with the eNB 200.

The first core information according to various embodiments may be received through at least one signal of a Master Information Block (MIB) or a System Information Block (SIB) broadcasted from the eNB 200.

The first core information according to various embodiments may be received through a new Information Element (IE) within a message of a Master Information Block (MIB) or a System Information Block (SIB).

For example, the new IE may include information of AssociatedCoreInfo={4G, 5G, Both, Spare}.

The first core information according to various embodiments may be received through a specific Public Land Mobile Network (PLMN) within a System Information Block (SIB) message.

For example, information of “5G Core is associated” may be included in a PLMN A field.

In operation 403, the UE 100 may select one of a plurality of core networks based on the first core information.

One of the plurality of core networks according to various embodiments may be selected by the UE 100 based on at least one piece of information on a Dual Connectivity (DC) development option and a service type, and core information related to a core network connected to the eNB 200. This will be described with reference to FIGS. 9 to 11 and FIGS. 12A to 12B.

The UE 100 may transmit a random access preamble to the eNB 200 in operation 405, and may receive a Random Access Response (RAR) message from the eNB 200 and attempt a random access procedure in operation 407.

The first core information according to various embodiments may be received from the eNB 200 through the Random Access Response (RAR) message. In this case, operation 403 in which the UE 100 selects one of the plurality of core networks may be performed after operation 407 in which the first core information is received.

The first core information according to various embodiments may be transmitted through a specific Cell Radio Network Temporary Identifier (C-RNTI) within the Random Access Response (RAR) message.

For example, Radio Network Temporary Identifiers (RNTIs) may be allocated within a range of 16 bit values and specifications may specify RNTIs which can be used and ranges thereof within all available ranges. Some values are not allowed to be used as the RNTI and are referred to as “reserved RNTIs” in this specification. Specifications of current versions, they are within a range from FFF4 to FFFC in hexadecimal.

In operation 409, the UE 100 may transmit second core information related to the core network selected in operation 403 through an RRC connection request message (Msg3).

The second core information according to various embodiments may be transmitted through the IE within the RRC connection request message (Msg3).

For example, the IE may include information of “PreferredCoreInfo={4G, 5G, Both, Spare}.

The second core information according to various embodiments may be transmitted through an Language Code Identifier (LCID) field of a Media Access Control (MAC) header when the RRC connection request message (Msg3) is transmitted.

For example, the LCID field may include information of “LCID 12=5G Core preferred”.

In operation 411, the eNB 200 may generate an SRB corresponding to the core network which is selected by the UE 100 to access, based on the second core information received in operation 409.

For example, the eNB 200 may establish the SRB (default SRB) of the LTE-PDCP version corresponding to the 4G core network 300 if the selected core network selected is the 4G core network 300. The eNB 200 may establish the SRB of the NR-PDCP version corresponding to the 5G core network 400 through the RRC connection establishment procedure without establishing the default SRB if the selected core network is the 5G core network 400.

In operation 413, the UE 100 may receive an RRC connection setup message (Msg4) from the eNB 200.

In operation 415, the UE 100 may generate the SRB corresponding to the selected core networks.

For example, the eNB 200 may establish the SRB (default SRB) of the LTE-PDCP version corresponding to the 4G core network 300 if the selected core network is the 4G core network 300. The eNB 200 may establish the SRB of the NR-PDCP version corresponding to the 5G core network 400 through the RRC connection establishment procedure without establishing the default SRB if the selected core network is the 5G core network 400.

In operation 417, the UE 100 may transmit the NAS message corresponding to the selected core network through an RRC connection setup complete message (Msg5).

For example, the NAS message may include an attach request message.

In operation 419, the eNB 200 may transmit the NAS message received in operation 417 to the selected core network.

For example, when the selected core network is the 4G core network 300, the eNB 200 may transmit the NAS message including an attach request message for accessing the MMF of the 4G core network 300 through an initial UE message in operation 421.

For example, when the selected core network is the 5G core network 400, the eNB 200 may transmit the NAS message including an attach request message for accessing the AMF of the 5G core network 400 through an initial UE message in operation 423.

In operation 425, a radio bearer may be established between the NAS layer of the UE 100 and the NAS layer of the selected core network in the wireless communication system.

For transmission of the NAS message according to various embodiments, an ECM connection is established between the NAS layer of the UE 100 and the NAS layer of the core network (the MME of the 4G core network 300 or the AMF of the 5G core network 400), and the ECM connection may include an RRC connection established between the UE 100 and the eNB 200 and an S1 signaling connection between the eNB 200 and the core network (the MME of the 4G core network 300 or the AMF of the 5G core network 400).

For example, when the AMF of the 5G core network 400 or the MME of the 4G core network 300 receives the initial UE message from the eNB 200, the signaling connection may be established between the eNB 200 and the core network.

In operation 427, the eNB 200 may establish a DRB corresponding to the selected core network.

In operation 429, the eNB 200 may transmit an RRC connection reconfiguration message to the UE 100.

In operation 431, the UE 100 may establish the DRB corresponding to the selected core network.

In operation 433, the UE 100 may transmit an RRC connection reconfiguration complete message to the eNB 200.

FIGS. 5A to 5B and 6 illustrate a method by which the core network performs an initial access procedure (mobile terminated) on the eNB 200 and the UE 100 by triggering a call in a wireless communication system supporting a plurality of communication systems according to various embodiments.

FIGS. 5A to 5B are a flowchart illustrating a method by which the core network performs triggering and establishes a Signaling Radio Bearer (SRB) in a wireless communication system supporting a plurality of communication systems according to various embodiments.

The eNB 200 may receive a paging message transmitted from the core network triggering a call in operation 501 or 503 and the eNB 200 may identify the paging message in operation 505.

For example, the eNB 200 may receive the paging message from the 4G core network 300 triggering a call in operation 501 and may receive the paging message from the 5G core network 400 triggering a call in operation 503.

The UE 100 may receive the paging message broadcasted from the eNB 200 in operation 507 and the UE 100 may identify the paging message in operation 509.

Operations 511 to 523 include a random access operation between the UE 100 and the eNB 200, an operation for establishing an SRB (default SRB) of an LTE-PDCP version corresponding to the 4G core network 300 during an RRC connection establishment procedure, and an operation for transmitting core information (e.g., second core information) on a core network which the UE 100 desires to access and an NAS message corresponding to the core network which the UE 100 desires to access through an RRC connection setup complete message (Msg5), which correspond to operations 303 to 315 of FIG. 3.

In the wireless communication system according to various embodiments, when the core network which the eNB 200 identified from the paging message matches the core network which the UE 100 desires to access, identified from the RRC connection setup complete message (Msg5), the UE 100 and the eNB 200 may perform operations 525 to 541.

Operations 525 to 541 may include an operation for transmitting the NAS message received in operation 523 to the core network which the UE 100 desires to access, generating a signaling connection between the eNB 200 and the core network which the UE desires to access, reestablishing an SRB corresponding to the core network which the UE 100 desires to access by the UE 100 and the eNB 200, and establishing a DRB corresponding to the core network which the UE 100 desires to access through an RRC connection reconfiguration procedure, which correspond to operations 317 to 333 of FIG. 3.

In the wireless communication system according to various embodiments, when the core network which the eNB 200 identified from the paging message does not match the core network which the UE 100 desires to access, identified from the RRC connection setup complete message (Msg5), the UE 100 and the eNB 200 may perform operations 543 to 545.

Operations 543 to 545 are operations in which the eNB 200 makes a request for RRC connection release to the UE 100 and the UE 100 attempts a reconnection, which correspond to operations 335 to 337 of FIG. 3.

FIG. 6 is a flowchart illustrating a method by which the core network performs triggering and establishes a Signaling Radio Bearer (SRB) in a wireless communication system supporting a plurality of communication systems according to various embodiments.

The eNB 200 may receive a paging signal from the core network triggering a call in operation 601 or 603, and may identify first core information which is information related to the core network triggering the call included in the paging signal in operation 605.

For example, the eNB 200 may receive the paging message transmitted from an MME of the 4G core network 300 triggering a call in operation 601 and may receive the paging message transmitted from an AMF of the 5G core network 400 triggering a call in operation 603.

The UE 100 may receive first core information which is information related to the core network triggering the call in operation 607 and may identify the first core information in operation 609.

The first core information according to various embodiments may be received through an IE within the paging message broadcasted from the eNB 200.

For example, the IE may include OriginatedCoreInfo={4G, 5G, Both, Spare}.

Operations 611 to 637 may include a random access operation between the UE 100 and the eNB 200, an operation for selecting the core network which the UE 100 desires to access, an operation for transmitting second core information related to the selected core network through an RRC connection request message (Msg3), an operation for establishing an SRB corresponding to the core network selected by the UE 100 through an RRC connection establishment procedure in the initial connection by the UE 100 and the eNB 200, an operation for transmitting an NAS message including an attach request message to the eNB 200 through an RRC connection setup complete message (Msg5) by the UE 100 and transmitting the NAS message to the core network selected by the UE 100 by the eNB 200, and an operation for establishing a DRB corresponding to the core network which the UE 100 desires to access through an RRC connection reconfiguration procedure by the UE 100 and the eNB 200, which correspond to operations 405 to 433 of FIG. 4.

FIGS. 7 and 8A to 8B illustrate a method of performing handover between a first eNB accessing first Radio Access Technology (RAT) and a second eNB accessing second RAT in a wireless communication system supporting a plurality of communication systems according to various embodiments.

The wireless communication system may include a UE 500, a source eNB 510, a target eNB 520, a source MME 530, a target AMF 540, a source 4G Serving Gateway (SGW) 550, a target Session Management Function (SMF)-Packet Gateway (PGW)-C 560, a target User Plane Function (UPF)-PGW-U 570, and a Policy Control Function (PCF)-Policy and Charging Rules Function (PCRF) 580.

The UE 500 according to various embodiments may perform inter-system handover between a source eNB 510 supporting only the 4G radio access technology and a target eNB 520 capable of interworking with both the 4G radio access technology and the 5G radio access technology, thereby performing handover from the 4G core network to the 5G core network.

FIG. 7 is a flowchart illustrating an inter-system handover method between the non-eLTE eNB (e.g., 4G eNB) and the eLTE eNB interworking with the 5G core network in a wireless communication system supporting a plurality of communication systems according to various embodiments.

In operation 701, the UE 500 may transmit an RRC message to a source eNB 510.

For example, the RRC message may include a measurement report message.

For example, the UE 500 may measure intensities of received signals of adjacent cells and periodically report the same, and when measurement values meet a condition given by measurement configuration and a measurement event is trigged, may provide a measurement report.

In operation 703, the source eNB 510 may determine a target eNB 520 and a type of handover to be performed based on the RRC message received in operation 701.

For example, the source eNB 510 may determine intra-system handover (HO) to the target eNB 520.

When the source eNB 510 determines the intra-system HO in operation 703, the source eNB 510 may transmit a handover request message to the target eNB 520 in operation 705 or may transmit a handover required message to a source MME 530 in operation 707.

In operation 709, handover (X2 handover) using the conventional X2 interface or handover (S1 handover) using the S1 interface may be performed in the wireless communication system.

For example, the handover may be divided into the handover (X2 handover) using the X2 interface and the handover (S1 handover) using the S1 interface according to whether preparation and execution of the handover between the source eNB 510 and the target eNB 520 are performed without or with intervention of the EPC.

In operations 711 to 713, the UE 500 and the target eNB 520 may establish the default SRB and the default DRB corresponding to the 4G core network through the handover procedure.

When the UE 500 or the bearer can interwork with the 5G core network which the UE 500 desires to access, the target eNB 520, the target eNB 520 may move from the 4G core network (EPC) 300 to the 5G core network (5GC) by performing the inter-system handover one more time based on the conventional N26 interface in operations 715 to 719.

The UE 500 and the target eNB 520 may reestablish the SRB and the DRB corresponding to the 5G core network selected by the UE 500 in operations 721 to 723.

FIGS. 8A and 8B are a flowchart illustrating an inter-system handover method between the source eNB (non-eLTE eNB) 510 and the target eNB (eLTE eNB) 520 interworking with the 5G core network in a wireless communication system supporting a plurality of communication systems according to various embodiments. Examples of the source eNB 510 may include a 4G eNB.

Operations 801 to 803 may include an operation in which the UE 500 receives first core information, which is information related to one or more core networks associated with the target eNB 520, from the target eNB 520 and an operation in which the UE 500 selects the core network which the UE 500 desires to access based on the first core information, which correspond to operations 401 to 403 of FIG. 4.

In operation 805, the UE 500 may transmit second core information related to the core network selected in operation 803 to the source eNB 510.

For example, the second core information may be transmitted through a measurement report message.

In operation 807, the source eNB 510 may determine whether to perform inter-system handover (HO) between the 4G core network (EPC) and the 5G core network (5G core) based on the second core information received from the UE 500.

When the source eNB 510 determines the inter-system handover (HO) in operation 807, the source eNB 510 may transmit a handover required message to the source MME 530 in operation 809.

In operation 811, the source MME 530 may perform the handover procedure between the 4G core network (EPC) and the 5G core network (5G core) through the N26 interface.

The handover procedure may be performed in operation 811 and may be completed in operation 833.

In operations 813 to 815, the target eNB 520 may receive the handover request message from the target AMF 540 and may transmit a handover request acknowledge message to the target AMF 540.

In operation 817, the target eNB 520 may establish an SRB and a DRB corresponding to the core network selected by the UE 500.

In operation 821, the source eNB 510 may receive a handover command message from the source MME 530.

In operation 823, the source eNB 510 may transmit an RRC message including second core information to the UE 500.

For example, the source eNB 510 may transmit second core information related to the core network selected by the UE 500 through an RRC connection reconfiguration message.

In operation 825, the UE 500 may establish the SRB and the DRB corresponding to the core network selected by the UE 500 based on the second core information received in operation 823.

The UE 500 may transmit a random access preamble to the target eNB 520 in operation 827, and may receive a Random Access Response (RAR) message from the target eNB 520 and attempt a random access procedure in operation 829.

In operation 831, the target eNB 520 may transmit an RRC message indicating handover completion to the target eNB 520. For example, the RRC message may be an RRC connection reconfiguration complete message.

In operation 833, the wireless system may terminate the handover procedure.

As illustrated in FIGS. 8A and 8B, when the handover from the 4G core network to the 5G core network is performed, if the core network which the UE 500 desires to access is the 5G core network, the UE 500 and the target eNB 520 may establish the SRB and the DRB of the NR-PDCP version corresponding to the 5G core network through the handover procedure without establishing the default SRB nor the default DRB.

FIG. 9 is a conceptual diagram illustrating a method of identifying a core network which can interwork with the UE 100, 500 in a wireless communication system supporting a plurality of communication systems according to various embodiments.

The wireless communication system according to various embodiments may include a Dual Connectivity (DC) development option by which 4G radio access technology (LTE) and 5G radio access technology (NR) interwork.

The DC development option according to various embodiments may include at least one of E-URTA-NR Dual Connectivity (EN-DC), NR-RAN E-UTRA-NR Dual Connectivity (NGEN-DC), and NR-E-UTRA Dual Connectivity (NE-DC).

For example, the EN-DC is a structure interworking with the 4G core network (EPC) in a structure in which DC in which LTE is a master node and NR is a secondary node is supported.

For example, the NGEN-DC is a structure interworking with the 5G core network (NR Core, 5GC) in a structure in which DC in which LTE is a master node and NR is a secondary node is supported.

For example, the EN-DC is a structure interworking with the 5G core network (NR core, 5GC) in a structure in which DC in which NR is a master node and LTE is a secondary node is supported.

In the wireless communication system supporting a plurality of communication systems according to various embodiments, the UE 100, 500 may select one core network which the UE 100, 500 desires to access from among a plurality of core networks.

One core network among a plurality of core networks according to various embodiments may be selected based on at least one piece of information on a DC option type supported by the UE 100, 500, a service type to be used by the UE 100, 500, and a core network type supported by the eNB.

For example, the DC option type supported by the UE 100, 500 may include at least one of E-URTA-NR Dual Connectivity (EN-DC), NR-RAN E-UTRA-NR Dual Connectivity (NGEN-DC), NR-RAN E-UTRA-NR Dual Connectivity (NGEN-DC), and an (LTE only) option for only supporting 4G radio access technology (LTE RAT) without supporting DC.

The UE 100, 500 according to various embodiments may determine RAT supportable by the UE and a core network which can interwork according to DC capability.

When the UE is turned on in operation 901, the UE 100, 500 may identify DC capability supportable by the UE 100, 500 in operation 903.

When it is identified that the UE 100, 500 supports NR-RAN E-UTRA-NR Dual Connectivity (NGEN-DC) in operation 903, NR-RAN E-UTRA-NR Dual Connectivity (NGEN-DC) in operation 903, the UE 100, 500 may interwork with only the 5G core network (5GC).

When it is identified that the UE 100, 500 supports both the NGEN-DC and the EN-DC, in operation 903, the UE 100, 500 may interwork with both the 4G core network (EPC) and the 5G core network (5GC) in operation 907.

When it is identified that the UE 100, 500 supports only the EN-DC or the 4G RAT (LTE RAT) without supporting the DC in operation 903, the UE 100, 500 may interwork with only the 4G core network (EPC) in operation 909.

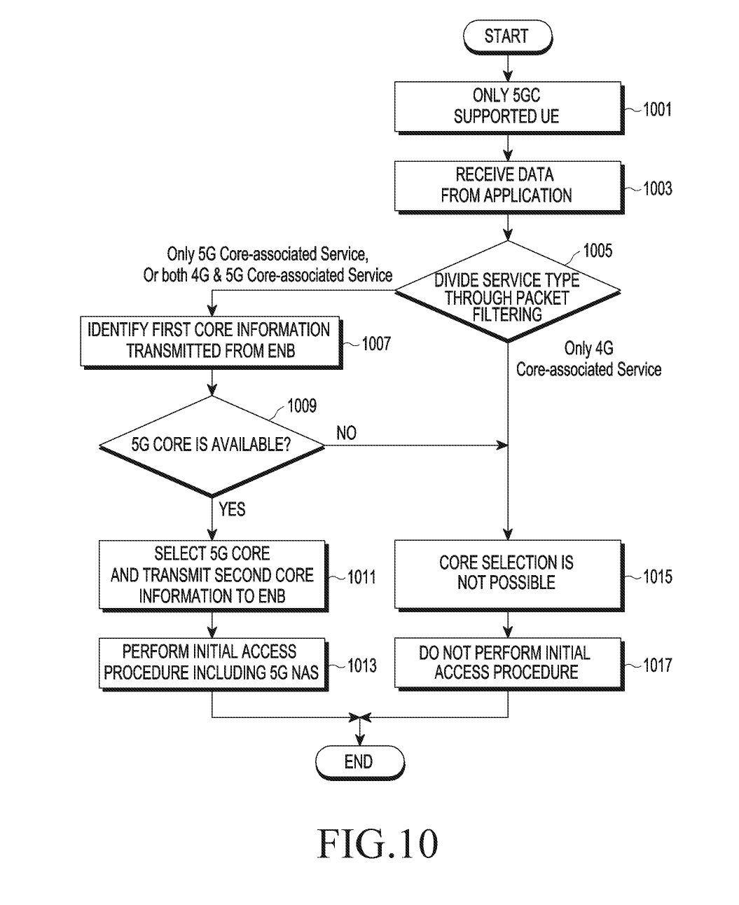

FIGS. 10 to 11 and FIGS. 12A to 12B are flowcharts illustrating various embodiments of a method of selecting one core network from a plurality of core networks according to a core network interworking with the UE 100, 500 and performing an initial access procedure in a wireless communication system supporting a plurality of communication systems according to various embodiments.

The initial access procedure according to various embodiments may include an attach procedure or an activation (idle to active) process.

FIG. 10 is a flowchart illustrating a method by which the UE 100, 500 capable of interworking with only the 5G core network (5GC) selects one core network from a plurality of core networks and performs an initial access procedure.

In operation 1001, it may be identified that the UE 100, 500 interworks with only the 5G core network (5GC).

In operation 1003, the UE 100, 500 may receive data from an application.

In operation 1005, through packet filtering, the UE 100, 500 may identify a service type for the corresponding application and a core type with which the corresponding service should interwork.

When the service type identified in operation 1005 is a service type e.g., voice over 5G) interworking with only the 5G core network or a service type (e.g., general Internet) interworking with both the 4G core network and the 5G core network, the UE 100, 500 may identify first core information transmitted from the eNB in operation 1007.

For example, the first core information may include information related one or more core networks associated with the eNB.

For example, the first core information may be received through at least one of a System Information Block (SIB), a Master Information Block (MIB), and a Random Access Response (RAR).

For example, in operation 1007, the first core information may be received through an MIB transmitted to a Physical Broadcast Channel (PBCH).

In operation 1009, the UE 100, 500 may identify whether the eNB interworks with the 5G core network (5GC).

When it is identified that the eNB interworks with the 5G core network (5GC) in operation 1009, the UE 100, 500 may select the 5G core network and transmit second core information related to the selected 5G core network to the eNB in operation 1011.

For example, the second core information may be transmitted through an RRC message transmitted to the eNB.

For example, the second core information may be transmitted through an RRC connection request message (Msg3) transmitted to the eNB.

In operation 1013, the UE 100, 500 may perform an initial access procedure including an NAS message corresponding to the selected 5G core network.

Although not illustrated in FIG. 10, the eNB may establish an SRB of an NR-PDCP version corresponding to the 5G core network selected by the UE 100, 500 based on the second core information and transmit an RRC connection setup message to the UE 100, 500, and the UE 100, 500 may establish the SRB of the NR-PDCP version corresponding to the 5G core network.

Further, the UE 100, 500 may transmit the NAS message corresponding to the 5G core network to the eNB through the RRC message.

For example, the NAS message may include an attach request message and may be transmitted to the eNB through an RRC connection setup complete message (Msg5).

When the service type identified in operation 1005 is a service type (e.g., VoLTE) interworking with only the 4G core network (EPC) or when interworking between the eNB and the 5G core network (5GC) is not identified in operation 1009, the UE 100, 500 may not select the core in operation 1015 and may omit to perform the initial access procedure in operation 1017.

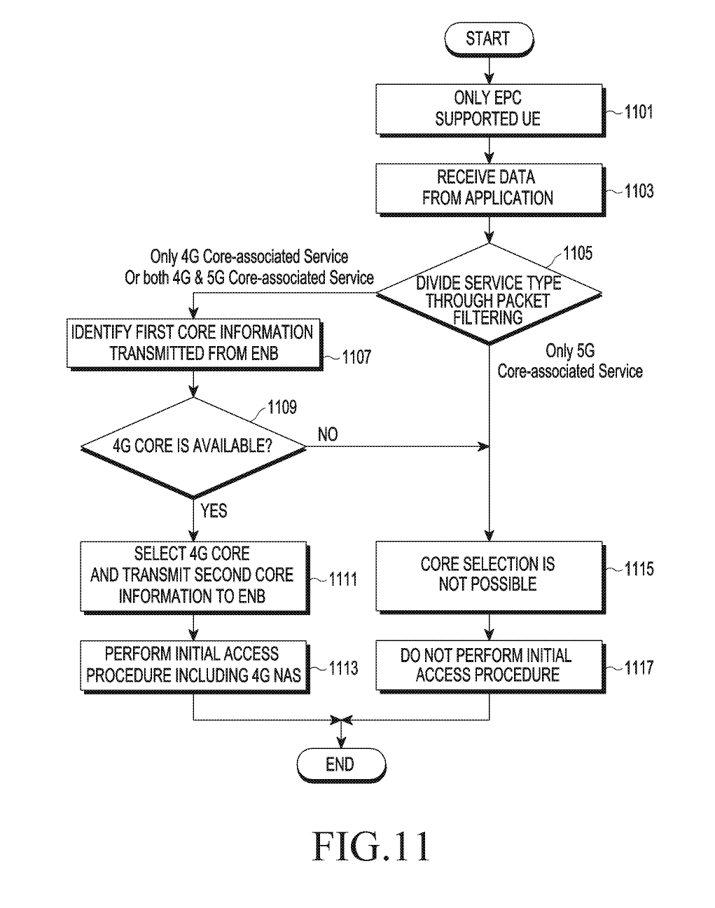

FIG. 11 is a flowchart illustrating a method by which the UE 100, 500 capable of interworking with only the 4G core network (EPC) selects one core network from a plurality of core networks and performs an initial access procedure.

In operation 1101, it may be identified that the UE 100, 500 interworks with only the 4G core network (EPC).

In operation 1103, the UE 100, 500 may receive data from an application.

In operation 1105, through packet filtering, the UE 100, 500 may identify a service type for the corresponding application and a core type with which the corresponding service may need to interwork.

When the service type identified in operation 1105 is a service type (e.g., VoLTE) interworking with only the 4G core network or a service type (e.g., general Internet) interworking with both the 4G core network and the 5G core network, the UE 100, 500 may identify first core information transmitted from the eNB in operation 1107.

For example, the first core information may include information related one or more core networks associated with the eNB.

For example, the first core information may be received through at least one of a System Information Block (SIB), a Master Information Block (MIB), and a Random Access Response (RAR).

For example, in operation 1107, the first core information may be received through an MIB transmitted to a Physical Broadcast Channel (PBCH).

In operation 1109, the UE 100, 500 may identify whether the eNB interworks with the 4G core network (EPC).

When it is identified that the eNB interworks with the 4G core network (EPC) in operation 1109, the UE 100, 500 may select the 4G core network and transmit second core information related to the selected 4G core network to the eNB in operation 1111.

For example, the second core information may be transmitted to the eNB through an RRC message.

For example, the second core information may be transmitted to the eNB through an RRC connection request message (Msg3).

In operation 1113, the UE 100, 500 may perform an initial access procedure including an NAS message corresponding to the selected 4G core network.

Although not illustrated in FIG. 10, the eNB may establish an SRB of an LTE-PDCP version corresponding to the selected 4G core network based on the second core information and transmit an RRC connection setup message (Msg4) to the UE 100, 500, and the UE 100, 500 may establish the SRB of the LTE-PDCP version corresponding to the 4G core network.

Further, the UE 100, 500 may transmit the NAS message corresponding to the 4G core network, to the eNB through the RRC message.

For example, the NAS message may include an attach request message and may be transmitted to the eNB through an RRC connection setup complete message (Msg5).

When the service type identified in operation 1105 is a service type (e.g., voice over 5G) interworking with only the 5G core network (5GC) or when interworking between the eNB and the 4G core network (EPC) is not identified in operation 1109, the UE 100, 500 may not select the core in operation 1115 and not perform the initial access procedure in operation 1117.

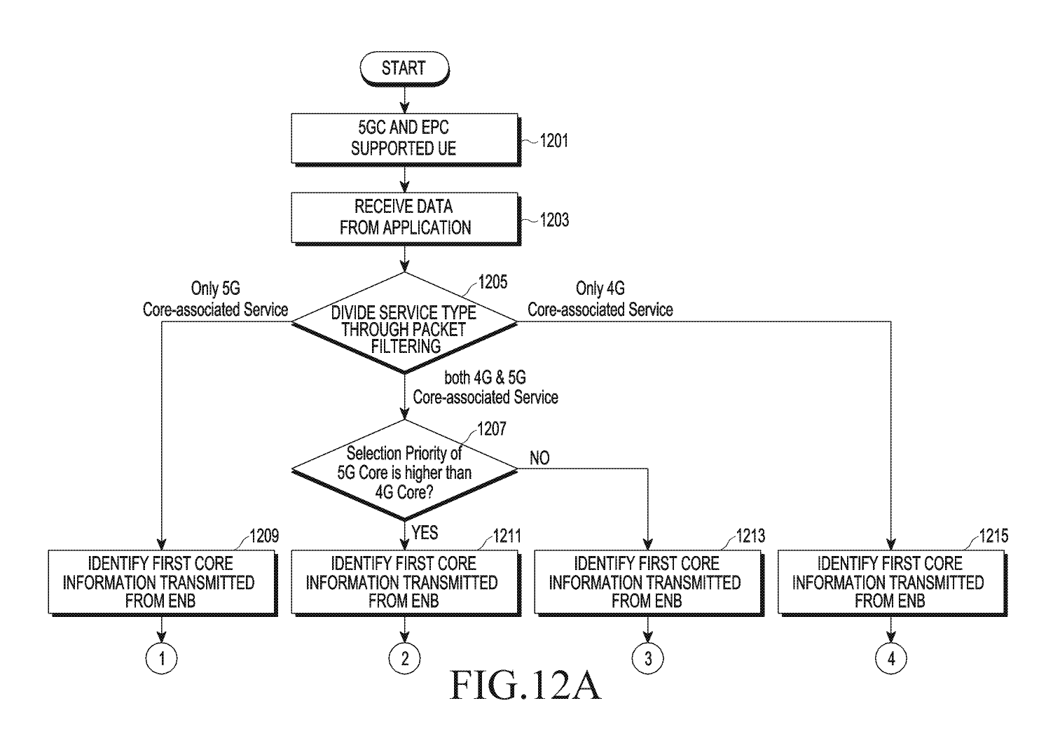

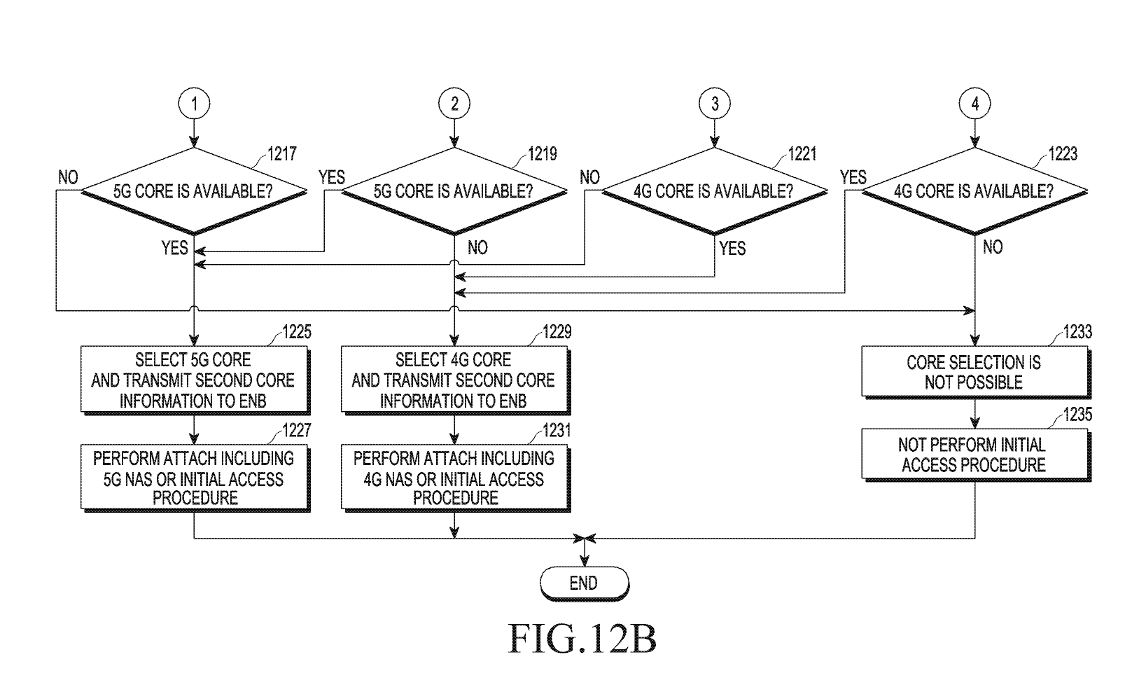

FIGS. 12A to 12B are a flowchart illustrating a method by which the UE 100, 500 capable of interworking with both the 4G core network (EPC) and the 5G core network (5GC) selects one core network from a plurality of core networks and performs an initial access procedure.

In operation 1201, it may be identified that the UE 100, 500 interworks with both the 4G core network (EPC) and the 5G core network (5GC).

In operation 1203, the UE 100, 500 may receive data from an application.

In operation 1205, through packet filtering, the UE 100, 500 may identify a service type for the corresponding application and a core type with which the corresponding service may need to interwork.

For example, when the service type identified in operation 1205 is a service type (e.g., voice over 5G) interworking with only the 5G core network, the UE 100, 500 may identify first core information transmitted from the eNB in operation 1209 and identify whether the eNB interworks with the 5G core network (5GC) in operation 1217.

When interworking between the eNB and the 5G core network (5GC) is identified in operation 1217, the UE 100, 500 may select the 5G core network and transmit second core information related to the selected 5G core network to the eNB in operation 1225, and may perform an initial access procedure including an NAS message corresponding to the selected 5G core network in operation 1227. Operation 1209 of FIG. 12A corresponds to operation 1007 of FIG. 10, and operations 1225 to 1227 of FIG. 12B correspond to operations 1011 to 1013 of FIG. 10.

When interworking between the eNB and the 5G core network (5GC) is not identified in operation 1217, the UE 100, 500 may not select the core in operation 1233 and may not perform the initial access procedure in operation 1235.

For example, when the service type identified in operation 1205 is a service type (e.g., VoLTE) interworking with only the 4G core network, the UE 100, 500 may identify first core information transmitted from the eNB in operation 1215 and identify whether the eNB interworks with the 4G core network (EPC) in operation 1223.

When interworking between the eNB and the 4G core network (EPC) is identified in operation 1223, the UE 100, 500 may select the 4G core network and transmit second core information related to the selected 4G core network to the eNB in operation 1229, and may perform an initial access procedure including an NAS message corresponding to the selected 4G core network in operation 1231. Operation 1215 of FIG. 12A corresponds to operation 1107 of FIG. 11, and operations 1229 to 1231 of FIG. 12B correspond to operations 1111 to 1113 of FIG. 11.

When interworking between the eNB and the 4G core network (EPC) is not identified in operation 1223, the UE 100, 500 may not select the core in operation 1233 and may not perform the initial access procedure in operation 1235.

For example, when the service type identified in operation 1205 is a service type (e.g., general Internet) interworking with both the 4G core network and the 5G core network, the UE 100, 500 may select a core network having a high priority based on a core network selection priority in operation 1207.

When the priority of the 5G core network is higher than that of the 4G core network in operation 1207, the UE 100, 500 may identify first core information received from the eNB in operation 1211 and identify whether the eNB interworks with the 5G core network (5GC) in operation 1219.

When interworking between the eNB and the 5G core network (5GC) is identified in operation 1219, the UE 100, 500 may select the 5G core network and transmit second core information related to the selected 5G core network to the eNB in operation 1225, and may perform an initial access procedure including an NAS message corresponding to the selected 5G core network in operation 1227. Operation 1211 of FIG. 12A corresponds to operation 1007 of FIG. 10, and operations 1225 to 1227 of FIG. 12B correspond to operations 1011 to 1013 of FIG. 10.

When it is identified that the eNB does not interwork with the 5G core network (5GC) in operation 1219, it may be determined that the eNB interworks with the 4G core network (EPC), and the UE 100, 500 may select the 4G core network and transmit second core information related to the selected 4G core network to the eNB in operation 1229, and may perform an initial access procedure including an NAS message corresponding to the selected 4G core network in operation 1231. Operation 1211 of FIG. 12A corresponds to operation 1107 of FIG. 11, and operations 1229 to 1231 of FIG. 12B correspond to operations 1111 to 1113 of FIG. 11.

For example, when the priority of the 4G core network is higher than that of the 5G core network in operation 1207, the UE 100, 500 may identify first core information received from the eNB in operation 1213 and identify whether the eNB interworks with the 4G core network (EPC) in operation 1221.

When it is identified that the eNB interworks with the 4G core network (EPC) in operation 1221, the UE 100, 500 may select the 4G core network and transmit second core information related to the selected 4G core network to the eNB in operation 1229, and may perform an initial access procedure including an NAS message corresponding to the selected 4G core network in operation 1231. Operation 1213 of FIG. 12A corresponds to operation 1107 of FIG. 11, and operations 1229 to 1231 of FIG. 12B correspond to operations 1111 to 1113 of FIG. 11.

When it is identified that the eNB does not interwork with the 4G core network (EPC) in operation 1221, it may be determined that the eNB interworks with the 5G core network (5GC), and the UE 100, 500 may select the 5G core network and transmit second core information related to the selected 5G core network to the eNB in operation 1225, and may perform an initial access procedure including an NAS message corresponding to the selected 5G core network in operation 1227. Operation 1213 of FIG. 12A corresponds to operation 1007 of FIG. 10 and operations 1225 to 1227 of FIG. 12B correspond to operations 1011 to 1013 of FIG. 10.

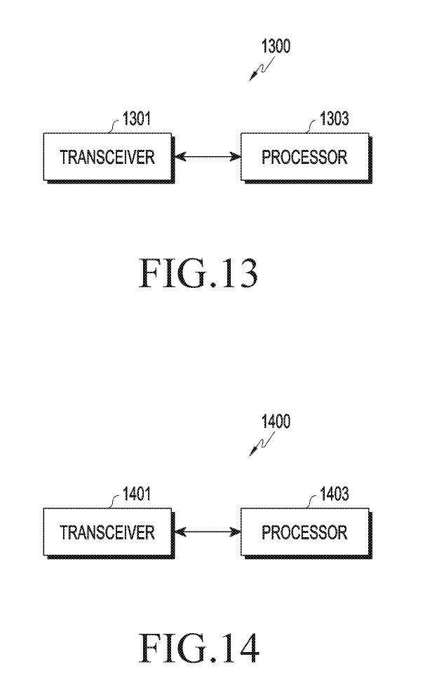

FIG. 13 is a block diagram of the UE 100, 500 capable of establishing a Signaling Radio Bearer (SRB) in a wireless communication system supporting a plurality of communication systems according to various embodiments.

As illustrated in FIG. 13, the UE 100, 500 according to various embodiments may include a transceiver and at least one processor.

Hereinafter, the elements will be sequentially described.

The transceiver according to various embodiments may transmit and receive signals, information, and data according to various embodiments to and from the eNB or a plurality of core networks.

The processor according to various embodiments may control the overall operation of the UE 100, 500. The processor may control the overall operation of the UE 100, 500 according to various embodiments as described above.

At least one processor according to various embodiments may control the transceiver to receive from the eNB first core information related to a plurality of core networks.

For example, the first core information may be received from the eNB through at least one of a System Information Block (SIB), a Master Information Block (MIB), a Random Access Response (RAR), and a paging message.

The processor according to various embodiments may select one core network from a plurality of core networks based on the core information received from the eNB.

For example, the plurality of core networks may include a 4G core network supporting radio access technology evolved from 4G and a 5G core network supporting 5G radio access technology. For example, the 4G core network may be an Evolved Packet Core (EPC), and the 5G core network may be a 5GC.

For example, one of the plurality of core networks may be selected by the UE 100, 500 based on at least one piece of information on a Dual Connectivity (DC) development option and a service type, and core information related to a core network connected to the eNB.

The processor according to various embodiments may control the transceiver to transmit second core information related to the selected core network to the eNB.

For example, the second core information may be transmitted through an RRC message transmitted to the eNB.

For example, the second core information may be transmitted through an RRC connection request message (Msg3) transmitted to the eNB.

Further, the second core information may be transmitted through an RRC connection setup complete message (Msg5) transmitted to the eNB.

In addition, the second core information may be transmitted through a measurement report message transmitted to the eNB.

The processor according to various embodiments may establish a Signaling Radio Bearer (SRB) corresponding to the selected core network.

For example, the SRB corresponding to the core network may include at least one of an SRB of an LTE-PDCP version and an SRB of an NR-PDCP version.

The processor according to various embodiments may control the transceiver to transmit an NAS message corresponding to the selected core network.

For example, the NAS message may include an access (attach) request message. Further, the NAS message may be transmitted through an RRC connection setup complete message (Msg5).

Meanwhile, the UE 100, 500 may further include a memory and may store a basic program for the operation of the UE 100, 500, an application, and data such as configuration information. Further, the memory may include at least one type of storage medium of a flash memory type, a hard disk type, a multimedia card micro type, a card type memory (e.g., an SD memory, an XD memory or the like), a magnetic memory, a magnetic disk, an optical disk, a Random Access Memory (RAM), a Static RAM (SRAM), a Read-Only Memory (ROM), a Programmable Read-Only Memory (PROM), and an Electrically Erasable Programmable ROM (EEPROM). The processor may perform various operations using a variety of programs, content, and data stored in the memory.

FIG. 14 is a block diagram of the eNB capable of establishing a Signaling Radio Bearer (SRB) in a wireless communication system supporting a plurality of communication systems according to various embodiments.

As illustrated in FIG. 14, the eNB according to various embodiments may include a transceiver and at least one processor.

Hereinafter, the elements will be sequentially described.

The transceiver according to various embodiments may transmit and receive signals, information, and data according to various embodiments to and from the UE 100, 500 or a plurality of core networks.

The processor according to various embodiments may control the overall operation of the eNB. The processor may control the overall operation of the eNB according to various embodiments as described above.

At least one processor according to various embodiments may control the transceiver to transmit first core information related to a plurality of core networks to the UE 100, 500.

Further, the first core information may be transmitted through at least one of a System Information Block (SIB), a Master Information Block (MIB), a Random Access Response (RAR), and a paging message.

The processor according to various embodiments may perform control to receive, from the UE 100, 500, second core information related to a core network selected from the plurality of core networks.

For example, the second core information may be received from the UE 100, 500 through an RRC message.

For example, the second core information may be received from the UE 100, 500 through an RRC connection request message (Msg3).

Further, the second core information may be received from the UE 100, 500 through an RRC connection setup complete message (Msg5).

In addition, the second core information may be received from the UE 100, 500 through a measurement report message.

The processor according to various embodiments may establish a signaling radio bearer corresponding to the core network selected by the UE 100, 500 based on received core selection information.

The processor according to various embodiments may control the transceiver to receive, from the UE 100, 500, an NAS message corresponding to the selected core network.

The processor according to various embodiments may control the transceiver to transmit the NAS message to the selected core network.

For example, the NAS message may include an access (attach) request message.

Further, the NAS message may be received from the UE 100, 500 through an RRC connection setup complete message (Msg5).

In addition, the NAS message may be transmitted to the selected core network through an initial UE message.

Meanwhile, the eNB may further include a memory and may store a basic program for the operation of the eNB, an application, and data such as configuration information. Further, the memory may include at least one type of storage medium of a flash memory type, a hard disk type, a multimedia card micro type, a card type memory (e.g., an SD memory, an XD memory or the like), a magnetic memory, a magnetic disk, an optical disk, a Random Access Memory (RAM), a Static RAM (SRAM), a Read-Only Memory (ROM), a Programmable Read-Only Memory (PROM), and an Electrically Erasable Programmable ROM (EEPROM). The processor may perform various operations using a variety of programs, content, and data stored in the memory.

Various embodiments described herein may be implemented within a computer-readable recording medium using, for example, software, hardware, or a combination thereof.

According to implementation in hardware, the embodiments described herein may be embodied using at least one of Application Specific/integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, and electrical units for executing other functions. In some cases, the embodiments may be implemented by the processor.

According to implementation in software, embodiments such as procedures or functions may be implemented together with a separate software module for performing at least one function or operation. Software code may be implemented by a software application written by an appropriate program language. Further, software code may be stored in a memory and executed by a processor.

In the above-described detailed embodiments of the disclosure, a component included in the disclosure is expressed in the singular or the plural according to a presented detailed embodiment. However, the singular form or plural form is selected for convenience of description suitable for the presented situation, and various embodiments are not limited to a single element or multiple elements thereof. Further, either multiple elements expressed in the description may be configured into a single element or a single element in the description may be configured into multiple elements.

The embodiments and the terms used therein are not intended to limit the technology disclosed herein to specific forms, and should be understood to include various modifications, equivalents, and/or alternatives to the corresponding embodiments. In describing the drawings, similar reference numerals may be used to designate similar constituent elements. A singular expression may include a plural expression unless they are definitely different in a context. The terms “A or B”, “one or more of A and/or B”, “A, B, or C”, or “one or more of A, B and/or C” may include all possible combinations of them. The expression “a first”, “a second”, “the first”, or “the second” used in various embodiments may modify various components regardless of the order and/or the importance but does not limit the corresponding components. When an element (e.g., first element) is referred to as being “(functionally or communicatively) connected,” or “directly coupled” to another element (second element), the element may be connected directly to the another element or connected to the another element through yet another element (e.g., third element).

The term “module” as used herein may include a unit consisting of hardware, software, or firmware, and may, for example, be used interchangeably with the term “logic”, “logical block”, “component”, “circuit”, or the like. The “module” may be an integrated component, or a minimum unit for performing one or more functions or a part thereof. For example, a module may be an Application-Specific Integrated Circuit (ASIC).

Various embodiments of the present disclosure may be implemented by software (e.g., program) including instructions stored in machine-readable storage media (e.g., internal memory or external memory). The machine is a device that can call the stored instructions from the storage media and operate according to the called instructions, and may include a terminal (e.g., terminal 1300 of FIG. 13) according to the various embodiments. The instructions, when executed by a processor (e.g., processor 1320 of FIG. 13 or processor 1420 of FIG. 14), may cause the processor to directly execute a function corresponding to the instructions or cause other elements to execute the function under the control of the processor. The instruction may include a code that is generated or executed by a compiler or interpreter.

The machine-readable storage media may be provided in the form of non-transitory storage media. Here, the term “non-transitory” only means that the storage media is tangible without including a signal, irrespective of whether data is semi-permanently or transitorily stored in the storage media.

While not restricted thereto, embodiments can be embodied as computer-readable code on a computer-readable recording medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. Also, an embodiment may be written as a computer program transmitted over a computer-readable transmission medium, such as a carrier wave, and received and implemented in general-use or special-purpose digital computers that execute the programs. Moreover, it is understood that in embodiments, one or more units of the above-described apparatuses and devices can include circuitry, a processor, a microprocessor, etc., and may execute a computer program stored in a computer-readable medium.

The method according to various embodiments disclosed herein may be included and provided in a computer program product. The computer program product may be traded as a product between a seller and a buyer. The computer program product may be distributed in the form of a machine-readable storage medium (e.g., compact disc read only memory (CD-ROM)), or may be distributed online via an application store (e.g., Play Store™). If distributed online, at least part of the computer program product may be temporarily generated or at least temporarily stored in the machine-readable storage medium, such as memory of the manufacturer's server, a server of the application store, or a relay server.

Each of the elements (e.g., modules or programs) according to various embodiments may include a single entity or multiple entities, and in various embodiments, some sub elements among the above elements may be omitted, or other sub elements may be added. Alternatively or additionally, some elements (e.g., modules or programs) may be integrated into a single element, and the integrated element may still perform the functions performed by each of the corresponding elements in the same or similar manner as before the corresponding elements are integrated. Operations performed by a module, a programming module, or other elements according to various embodiments may be executed sequentially, in parallel, repeatedly, or in a heuristic manner. At least some operations may be executed according to another sequence, may be omitted, or may further include other operations.

The foregoing embodiments are merely examples and are not to be construed as limiting. The present teaching can be readily applied to other types of apparatuses. Also, the description of the embodiments is intended to be illustrative, and not to limit the scope of the claims, and many alternatives, modifications, and variations will be apparent to those skilled in the art.

What is claimed is:

1. A method for a User Equipment (UE) in a wireless communication system supporting a plurality of communication systems, the method comprising:
receiving, from a base station (BS), first core information related to a plurality of core networks;
selecting a core network from among the plurality of core networks based on the first core information;
transmitting, to the BS, second core information related to the selected core network; and
establishing a Signaling Radio Bearer (SRB) between the UE and the selected core network, based on the second core information.

2. The method of claim 1, wherein the receiving the first core information comprises receiving the first core information through at least one of a System Information Block (SIB), a Master Information Block (MIB), a Random Access Response (RAR), and a paging message.

3. The method of claim 1, wherein the transmitting second core information comprises transmitting the second core information through a Radio Resource Control (RRC) message.

4. The method of claim 1, further comprising transmitting a Non-Access-Stratum (NAS) message that corresponds to the selected core network and includes an attach request message.

5. The method of claim 4, wherein the transmitting the NAS message comprises transmitting the NAS message through a Radio Resource Control (RRC) connection setup complete message.

6. A method for a base station (BS) in a wireless communication system supporting a plurality of communication systems, the method comprising:
transmitting, to a User Equipment (UE), first core information related to a plurality of core networks;
receiving, from the UE, second core information related to a core network selected from among the plurality of core networks; and
establishing a Signaling Radio Bearer (SRB) between the UE and the selected core network, based on the second core information.

7. The method of claim 6, wherein the transmitting the first core information comprises transmitting the first core information through at least one of a System Information Block (SIB), a Master Information Block (MIB), a Random Access Response (RAR), and a paging message.

8. The method of claim 6, wherein the receiving the second core information comprises receiving the second core information through a Radio Resource Control (RRC) message.

9. The method of claim 6, further comprising:
receiving, from the UE, a Non-Access-Stratum (NAS) message that corresponds to the selected core network and includes an attach request message; and
transmitting the NAS message to the selected core network.

10. The method of claim 9, wherein the receiving the NAS message comprises receiving the NAS message through a Random Access Response (RRC) connection setup complete message from the UE, and
wherein the transmitting the NAS message comprises transmitting the NAS message through an initial UE message to the selected core network.

11. A User Equipment (UE) in a wireless communication system supporting a plurality of communication systems, the UE comprising:
a transceiver; and
at least one processor,
wherein the at least one processor is configured to:
control the transceiver to receive, from a base station (BS), first core information related to a plurality of core networks,
select a core network from among the plurality of core networks based on the first core information,
control the transceiver to transmit, to the BS, second core information related to the selected core network, and
establish a Signaling Radio Bearer (SRB) between the UE and the selected core network, based on the second core information.

12. The UE of claim 11, wherein the at least one processor is further configured to control the transceiver to receive the first core information from the BS through at least one of a System Information Block (SIB), a Master Information Block (MIB), a Random Access Response (RAR), and a paging message.

13. The UE of claim 11, wherein the second core information is transmitted to the BS through a Radio Resource Control (RRC) message.

14. The UE of claim 11, wherein the at least one processor is further configured to control the transceiver to transmit a Non-Access-Stratum (NAS) message that corresponds to the selected core network, and includes an attach request message.

15. The UE of claim 14, wherein the at least one processor is further configured to control the transceiver to transmit the NAS message through a Radio Resource Control (RRC) connection setup complete message.

16. A base station (BS) in a wireless communication system supporting a plurality of communication systems, the BS comprising:
a transceiver; and
at least one processor,
wherein the at least one processor is configured to:
control the transceiver to transmit, to a User Equipment (UE), first core information related to a plurality of core networks,
control the transceiver to receive, from the UE, second core information related to a core network selected from the plurality of core networks, and
establish a Signaling Radio Bearer (SRB) between the UE and the selected core network, based on the second core information.

17. The BS of claim 16, wherein the at least one processor is further configured to control the transceiver to transmit the first core information to the UE through at least one of a System Information Block (SIB), a Master Information Block (MIB), a Random Access Response (RAR), and a paging message.

18. The BS of claim 16, wherein the at least one processor is further configured to control the transceiver to receive second core information from the UE through a Radio Resource Control (RRC) message.

19. The BS of claim 16, wherein the at least one processor is further configured to control the transceiver to receive, from the UE, a Non-Access-Stratum (NAS) message corresponding to the selected core network and to transmit the received NAS message to the selected core network, and
wherein the NAS message includes an attach request message.

20. The BS of claim 19, wherein the at least one processor is further configured to:
control the transceiver to receive the NAS message, from the UE, through an RRC connection setup complete message (Msg5), and
transmit the received NAS message to the selected core network through an initial UE message.
